(19) United States
(12) Patent Application Publication
(10) Pub. No.: US 2022/0095609 A1
(43) Pub. Date: Mar. 31, 2022

(54) FREEZING OF BIOLOGICAL MATERIAL

(71) Applicant: SCI-GROUP AS, Rud (NO)

(72) Inventors: Ivar Wergeland, Oslo (NO); Geir Olav Gogstad, Oslo (NO)

(21) Appl. No.: 17/418,474

(22) PCT Filed: Dec. 27, 2019
(86) PCT No.: PCT/EP2019/087082

§ 371 Date: Jun. 25, 2021

(30) Foreign Application Priority Data
Dec. 28, 2018 (DK) PA 2018 70869

(51) Int. Cl. A01N 1/02

(52) U.S. Cl. CPC A01N 1/0252; A01N 1/0294; A01N 1/0284

(57) ABSTRACT

The present invention relates to a method of freezing of biological material and a freezing apparatus for freezing of biological material.

### FIELD OF THE INVENTION

The present invention relates to a method of freezing of biological material and a freezing apparatus for freezing of biological material.

### BACKGROUND OF THE INVENTION

Cryopreservation of biological material such as e.g. cells, tissue, organs, blood products, embryos, sperm, stem cells, fish eggs, etc., entails freezing a biological material to low enough temperatures, such that chemical processes, which might otherwise damage the material are halted, thereby preserving the material.

The field of cryopreservation often aims to not only freeze the biological materials, but also to retain their viability, i.e. their ability to resume normal biological function after thawing. When freezing a biological material the fluid inside will undergo a phase transition during which ice crystals may form. The formation of ice crystals can cause damage to the biological material, such that it may not be viable after thawing.

A common procedure in cryopreservation is the utilization of so-called cryoprotectants such as e.g. DMSO (Dimethyl sulfoxide, (CH₃)₂SO)), glycerol and various alcohols. Cryoprotectants are substances which are assumed to protect biological materials during freezing by reducing ice crystal formation. However, many of the cryoprotectants used are inherently toxic to the biological material and need to be removed immediately after thawing of the biological material. It would therefore be preferable to cryopreserve without the addition of cryoprotectants or, alternatively, with less amount of cryoprotectant.

One type of standard protocol used in a cell laboratory prescribes placing the cryo-tubes with cell suspensions containing 5-10% DMSO into an ordinary freezer, e.g. a −20° C. freezer, for a period, e.g. 15-30 minutes. Thereafter, the samples are placed in a −80° C. freezer or in a container with dry ice for a period, e.g. 45 minutes, before the samples are finally inserted in a locator with liquid nitrogen for permanent storage. This procedure is largely developed empirically and used with minor modifications in different laboratories doing in vitro research. The method results in acceptable cell recovery as long as DMSO is removed quickly after thawing as it will otherwise damage the cells. Alternatively the cryoprotectant concentration is reduced to a less harmful level when growth medium is added after thawing.

This process of removing DMSO constitutes a considerable extra workload to the laboratory personnel, as well as being a challenge to the laboratory environment. The avoidance of DMSO, or even the possibility of using this chemical in significantly lower concentrations compared to current standards may not only provide a better opportunity to avoid cellular damage, but will also have major advantages to the laboratory working procedures.

An alternative to placing samples in an ordinary freezer is to make use of a controlled rate freezer, which can be set to control the cooling rate based on the temperature inside the freezer. Using such a device a freezing rate of −1° C./min is often recommended. Cryopreservation of biological material in a controlled rate freezer also entails the use of cryoprotectants as a standard.

An important factor in designing the standard protocols for cryopreservation is the viability, i.e. how much of the biological material is viable after thawing.

An improved method of cryopreservation, which results in tolerable viability-would be advantageous, and in particular a method whereby cryoprotectants are not needed to achieve tolerable viability would be advantageous.

When liquid water is cooled it undergoes a phase transition from liquid to solid at a critical temperature. The phase transition is a first-order transition, which means the water either absorbs or releases an amount of energy per volume known as the latent heat. During the phase transition the temperature of the water will remain constant as heat is added or removed and during this time the water is in a mixed-state, where some of it is in a liquid state and some is in a solid state. The temperature at which a phase transition happens can be called the critical temperature of the phase transition. When water is cooled the temperature of the water decreases until the critical temperature is reached. While cooling is still applied the temperature of the water remains constant until the latent heat has been removed from the water after which the temperature of the water, now in solid state, once again decreases. This means that there is a duration of time during which latent heat is being removed from the water.

The inventors have noted that the duration of latent heat removal during freezing is an important factor in cryopreservation. The time during which latent heat is removed in the process of freezing is the time when ice crystals may form. When standard cryopreservation protocols such as the ones described above are used the inventors have noted that the duration of latent heat removal is of the order of 20 minutes.

In WO 91/01635 a shorter duration of latent heat removal is also preferred. The document discloses a method, where different heat extraction rates are used; one rate is used while latent heat is being lost, while a second, and smaller, rate is used either when the temperature of the material starts to drop again, i.e. after the latent heat has been removed, or while latent heat is still being removed. In the disclosed invention cryoprotectants are used as standard.

### OBJECT OF THE INVENTION

It may be seen as an object of the invention to provide a method to freeze or cryopreserve biological material, preferably human or animal cells.

It may be seen as another object of the invention to provide an apparatus for freezing or cryopreservation of biological material, preferably human or animal cells.

It is an object of the present invention to wholly or partly overcome the above disadvantages and drawbacks of the prior art, in particular to avoid the use of cryoprotectants, or to lower the concentration of such cryoprotectants considerably.

Further objects of the present invention may be to provide an alternative to the prior art, lowering cytotoxic compounds in the freezing procedures, and to reduce the workload and environmental load on laboratory personnel performing freezing procedures.

### SUMMARY OF THE INVENTION

Thus, the above described object and several other objects are intended to be obtained in a first aspect of the invention by providing a method to freeze or cryopreserve human and/or animal cells in suspension or attached to a surface, wherein one or more samples of human and/or animal cells in suspension or attached to a surface contained in container(s) comprise one or more liquids, the method comprising:
determining the cooling needed such that the phase transition time of a calibration sample contained in a container is less than 12 minutes, preferably in the interval of 0.5 to 6 minutes and preferably chosen such as to ensure optimal viability of the cells of the sample;
cooling said one or more samples in the same manner as said calibration sample.

In some preferred embodiments, “optimal viability of the cells” refers to the phase transition time, such as substantially the phase transition time, for which most cells are kept viable with a given amount of cryoprotectant.

Preferably, less than 5% of cryoprotectant is added to the container containing the biological material. In some preferred embodiment, less than 7%, such as less 6.5%, preferably less than 6%, such as less than 6.5% of cryoprotectant is added to the container containing the biological material.

In some preferred embodiments, the cooling needed may be determined such that the phase transition time of a calibration sample contained in a contained is less than 6 minutes, such as less than 3 minutes.

Human or animal cells includes, but is not limited to: human or animal cells, cell lines, primary cells, stem cells, blood products, such as blood cells, tissue cells, embryos, sperm, and fish eggs.

The human or animal cells (in suspension) will in this document interchangeably be referred to as biological samples or biological material.

Further biological material, which could be frozen using the method or apparatus disclosed herein, includes, but is not limited to: organs, viruses, bacteria and other biological materials in general.

Determining the cooling needed means determining a cooling profile, i.e. determining one or more parameters of cooling such as, but not limited to, cooling rate, cooling power, starting temperatures, hold times, and other parameters known when cooling.

Cooling in the same manner means using the determined cooling profile.

The phase transition time will in this document interchangeably be referred to as the latent heat removal time or ice-forming time.

Herein, when a reference is made to a percentage of the total sample volume, this percentage is given in weight/volume (weight per volume).

In some preferred embodiments, the phase transition time for optimal cell viability may be based on experiments wherein one or more calibration sample(s) has been cooled alongside, such as e.g. at the same time or sequentially exposed to the same cooling cycle, one or more sample(s) and the one or more phase transition time(s) of the calibration sample and the viability of the sample is correlated to find an optimal phase transition time for the viability for the specific sample.

In some preferred embodiments, a catalogue of optimal phase transition times may be recorded for a range of different cells and/or DMSO content, such as for 1% DMSO content.

In some preferred embodiments, a catalogue may be, such as comprise, a list of phase transition times, preferably the optimal phase transition time, which list may be categorized under other factors, such as DMSO content and/or cell type.

The suspension is a liquid solution comprising the animal or human cells, where the cells represent a very small fraction of the total volume of the suspension. The number of cells per millilitre in the suspension is preferably in the range 60,000-100,000,000 cells/ml.

The process may be further influenced by application of a magnetic field, an electric field, or both. Such electric field may be pulsed or static. The magnetic field may be generated by a magnet from one side relative to the sample, or by two or more magnets oriented in any relative angle between 0-360° between the north and south magnetic poles. If both magnetic and electric fields are applied, they may be oriented in any angle between 0-360° relative to each other.

It is realized by the inventors that a shorter duration of latent heat removal is preferable to obtain improved and higher viability of biological material, which has been frozen, however if the latent heat removal phase is too short the other extrema happens such as with snap freezing, or flash freezing, which is the process by which samples are lowered to temperatures below −70° C. very rapidly using remedies such as dry ice, liquid nitrogen a.s.o.. Snap freezing achieves the same endpoint as slow rate-controlled freezing, but at an approximate rate of 100-1000° C./min, even as low as 10° C./min, compared to 1° C./min. For biologicals such as mammalian cells this results in very few or no surviving cells. Hence, in preferred embodiments, this invention relates to latent heat removal time taking place over a short, but significant time interval lasting between 0.5 minute and 6.0 minutes.

Several interesting experiments have been carried out by the inventors. For example, experiments carried out on two types of mammalian cells where the effect of reducing the duration of latent heat removal on viability was tested. The first experiment found a 1000-fold increase in cell survival determined by colony formation after freezing one type of live cells in absence of a cryoprotectant when the latent heat was removed in 4 minutes compared to when it was removed in 20 minutes. The second experiment found a pronounced increase in plating efficiency after thawing for both cell types tested if the ice-forming time was halved from about 6 min to about 3 min and as long as no DMSO was present. The plating efficiency for both cells having been frozen with an ice-forming time of 2 minutes and 3 minutes was close to that found for samples cooled with 5% DMSO for 30 min in −20C then 45 min in ˜−80C and final storage in liquid N2, which is one of the standard laboratory freezing procedures used today.

The inventors have therefore realized that in order to conserve optimal survival of cells an intermediate length latent heat removal time is preferable, such as not as short as possible nor as long as possible. This observation is crucial, as common knowledge dictates a latent heat removal phase, which is as short as possible. This will in sub-DMSO situations decrease the viability of the cells.

### BRIEF DESCRIPTION OF THE FIGURES

The present invention and preferred embodiments thereof will now be described in more detail with regard to the accompanying figures. The figures show ways of implementing the present invention and are not to be construed as being limiting to other possible embodiments falling within the scope of the attached claim set.

FIG. 1 is a graph showing a typical cooling curve for water. Sections of the curve is fitted with straight lines and demonstrate a method to determine the phase transition time, which is detailed in the description.

FIG. 2 is an illustration of a cooling plate with a sample to be cooled.

FIG. 3 is an illustration of a cooling plate with another sample to be cooled.

FIG. 4 is an illustration of a cooling device comprising two plates, which can close on each other.

FIG. 5 is an illustration of the cooling device in FIG. 4, where the plates are closed on each other.

FIG. 6A is an illustration of another cooling device comprising two plates, which can close on each other.

FIG. 6B is an illustration of the cooling device in FIG. 6B, where the plates are closed on each other.

FIG. 7 is an illustration of a cooling device comprising plates that have indentations for samples to be cooled.

FIG. 8 is an illustration of a cooling device comprising a wind-generating member.

FIG. 9A is an illustration of a cooling device comprising a cooling bath.

FIG. 9B is an illustration of another cooling device comprising a cooling bath and further comprising a cooling rod.

FIG. 9C is an illustration of another cooling device comprising a cooling bath and further comprising a bath circulator.

FIG. 9D is an illustration of a cooling device comprising a cooling bath and further comprising a stirring member.

FIG. 10 is an illustration of a cooling device comprising a rotating sample rack.

FIG. 11 is a graph showing a typical cooling curve for water and demonstrates a method to determine the phase transition time, which is detailed in the description.

FIG. 12 is a graph showing a typical cooling curve for water and demonstrates a method to determine the phase transition time, which is detailed in the description.

FIG. 13 is a flow-chart of a method according to the invention.

FIG. 14 is an illustration of a cooling device comprising an air stream and a holder.

FIG. 15 is an illustration of an apparatus and a magnet holder according to an embodiment of the present invention.

FIG. 16 is an illustration of a sample rack to be used in the apparatus according to an embodiment of the present invention.

FIG. 17 illustrates the distribution of pulsed electric field for parallel plate capacitor system (COMSOL Multiphysics).

FIG. 18 illustrates the electric field norm across the middle of the parallel plate capacitor system (COMSOL Multiphysics).

FIG. 19 illustrates the magnetic field norm streaming and magnetic flux density an apparatus according to an embodiment of the present invention.

FIG. 20 illustrates the magnetic flux density of an apparatus according to an embodiment of the present invention, from the top surface of lower magnet to bottom surface of the upper magnet in the center of the magnet.

FIG. 21 illustrates the magnetic flux density distribution above, inside and below an apparatus according to an embodiment of the present invention, along the line passing through the centre of the one magnet from each side.

FIG. 22 illustrates the magnetic flux density of an apparatus according to an embodiment of the present invention, from the top surface of lower magnet to bottom surface of the upper magnet at the center of the four-magnet junction.

FIG. 23 illustrates the magnetic flux density above, inside and below the apparatus according to an embodiment of the present invention.

FIG. 24 illustrates the magnitude of the magnetic flux density in the centre of an apparatus according to an embodiment of the present invention.

FIG. 25 schematically illustrates an embodiment of the invention according to which the sample is exposed to a magnetic field, the magnetic field is illustrated by a magnet with poles N and S. The magnetic field may be spatially static or spatially varying, e.g. by rotating the magnet;

FIG. 26 schematically illustrates an embodiment of the invention according to which the sample is exposed to a spatially varying magnetic field from two magnetic field generating means illustrated by two magnets in various relative positions to each other. The magnets may be kept in permanent, relative positions or continuously rotating; in the figure the spatially varying of the magnetic field is illustrated by for consecutive “snap-shots” between which the magnets are rotated as illustrated by the curved arrows. This figure may also be interpretated as illustrating four different spatially, static configuration which may be used in different embodiments of the invention.

FIG. 27 schematically illustrates an embodiment of the invention according to which the sample is exposed to a spatially static electrical field by electrical field generation means and a spatially static magnetic field.

FIGS. 28-30 schematically illustrate different embodiments of the invention according to which the sample is exposed to a spatially static magnetic field and a spatially static electrical field, but with different orientations relatively to each other.

FIG. 31 schematically illustrated an embodiment of the invention according to which the sample is exposed to a spatially static magnetic field and a spatially varying electrical field illustrated by the electrical field generation means are rotated (curved arrows).

FIG. 32 schematically illustrated an embodiment of the invention according to which the sample is exposed to a spatially varying magnetic field and a spatially varying electrical field illustrated by the electrical field generation means and the magnetic field generation means are rotated (curved arrows); FIG. 32 shows two of several possible positions that may be permanent or two snap-shots of continuously rotating fields.

FIGS. 33A-C schematically illustrate different waveforms, square-shaped forms, of the electrical voltage applied to the electrical field generation means; although a similar variation in electrical field is aimed at, the material of the electrical field generation will provide a slightly distorted electrical field. In FIG. 33A the waveform is “Square-shaped, equally distributed in time and magnitude”. In FIG. 33B the waveform is Square-shaped, equally distributed in time and skewed in magnitude“. In FIG. 33C the waveform is “Square-shaped, equally distributed in time and biased magnitude towards either positive (shown) or negative)”.

FIGS. 34A-C schematically illustrate different waveforms, smooth forms, such as sinusoidal, of the electrical voltage applied to the electrical field generation means. In FIG. 34A the waveform is “Smooth-shaped, equally distributed in time and magnitude”. In FIG. 34B the waveform is Smooth-shaped, equally distributed in time and skewed in magnitude“. In FIG. 34C the waveform is “Smooth-shaped, equally distributed in time and biased magnitude towards either positive (shown) or negative)”.

FIG. 35 schematically illustrates a further embodiment of the invention in which a catalogue of optimal latent heat phase transition times are produced and used.

### DETAILED DESCRIPTION OF PREFERRED EMBODIMENT

Thus, the above described object and several other objects are intended to be obtained in a first aspect of the invention by providing a method of freezing a biological sample, the method comprising controlling the phase transition time of the one or more liquids of a biological sample.

In the case where the phase change from liquid to solid phase of the one or more liquids of the biological sample to be frozen is not detectable, the time interval of the phase transition is that of a suitable calibration sample such as e.g. an isotonic saline solution. An isotonic saline solution, also referred to as physiological saline or normal saline, contains 9 grams of NaCl dissolved in water to a total volume of 1000 ml, i.e. it is a solution of 0.90% w/v of NaCl.

An alternative calibration sample is the cryopreservation medium or growth medium, containing serum or being serum-free.

A further calibration sample is an isotonic salt solution or a cryopreservation medium or growth medium containing a cytotoxic and/or antibacterial substance.

Another alternative calibration sample is one or more of the biological samples to be frozen by introduction of a (sterile) temperature sensor directly to the sample to be frozen.

The time interval of the phase transition may then be calibrated by measuring the temperature of a suitable calibration sample in a container, while the container is being cooled. The time interval is then determined according to a definition of the phase transition time.

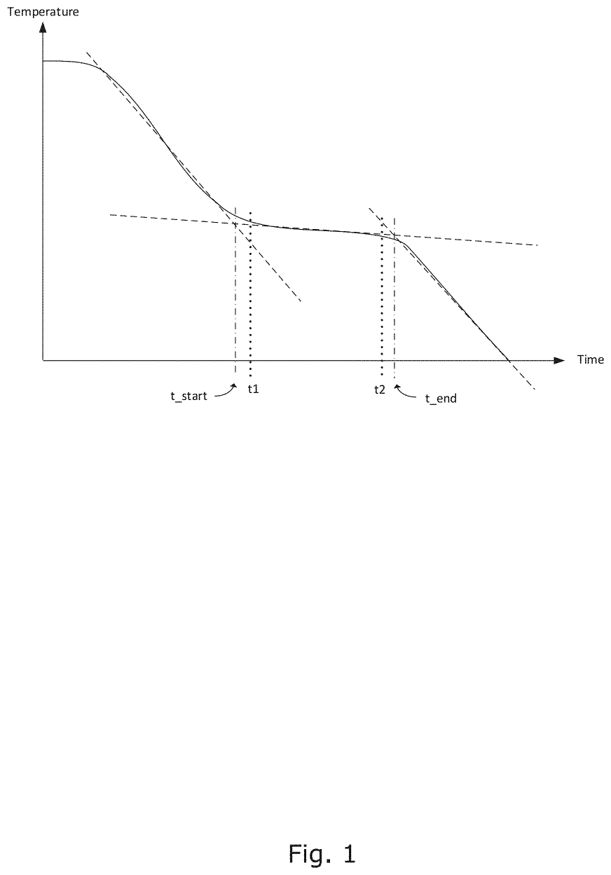

A (first) method to define the phase transition time is given below and with reference to FIG. 1, which shows a typical cooling curve (solid line) for an isotonic saline solution that is cooled at a cooling rate that is close to constant:
1. Fit a straight line to the part of the cooling curve, where the temperature is falling/decreasing, in a time interval before the curve flattens out due to the latent heat of fusion (dashed line in FIG. 1). The data set to fit the straight line to may be defined by changes in the first and/or second derivatives of the cooling curve.
2. Define t_start as the time, where the temperature data points close to the freezing point deviate from the straight line fitted in 1) by 0.5 degrees Celsius (dash-dotted line in FIG. 1).
3. Fit a straight line to the part of the cooling curve, where the temperature is falling/decreasing, in a time interval after the curve flattens out due to the latent heat of fusion (dashed line in FIG. 1). The data set to fit the straight line to may be defined by changes in the first and/or second derivatives of the cooling curve.
4. Define t_end as the time, where the temperature data points close to the freezing point deviate from the straight line fitted in 3) by 0.5 degrees Celsius (dash-dotted line in FIG. 1).
5. Fit a straight line to the temperature data in the time interval between t_start and tend.
6. Define t1 as the time closest to t_start, where the temperature data points deviate from the straight line fitted in 5) by 0.25 degrees Celsius and t2 as as the time closest to tend, where the temperature data points deviate from the straight line fitted in 5) by 0.25 degrees Celsius (dotted lines in FIG. 1).
7. The phase transition time or time of latent heat removal is then the time interval between t1 and t2.

In the above outlined method, any spurious data points may be disregarded in the process of defining t_start, tend, t1 and t2.

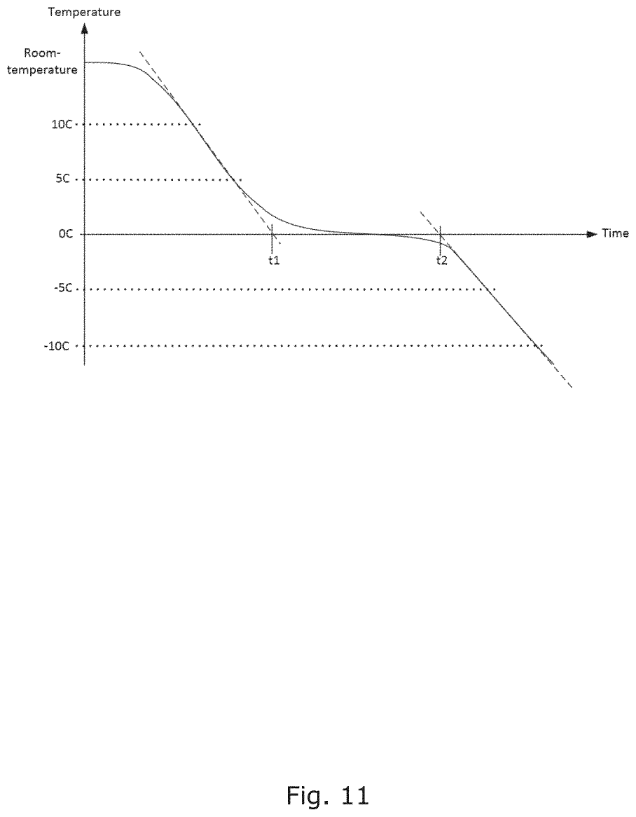

Another, second, method to define the phase transition time is given below and with reference to FIG. 11:
1. Determine the straight line that goes through the data points with temperature values 5C and 10C and determine the straight line that goes through the data points with temperature values −5C and −10C.
2. Determine the values on the abscissa, where the lines found in step 1, cross, i.e. the points (t1, 0C) and (t2, 0C).
3. The phase transition time or time of latent heat removal is then the time interval between t1 and t2.

Cooling may comprise cooling from room temperature to a lower temperature, such as 5C, 4C, 3C, 2C or 1C, and staying at this temperature, T_lower, for a period of time. In this case the first method to define the phase transition time described above can still be used. However, the second method described may only be used to determine t2. The value of t1 may be determined by determining a straight line that goes through a temperature lower than T_lower and a temperature higher than 0C and then following steps 2 and 3 in the second method.

Another, fourth, method to define the phase transition time, when cooling to

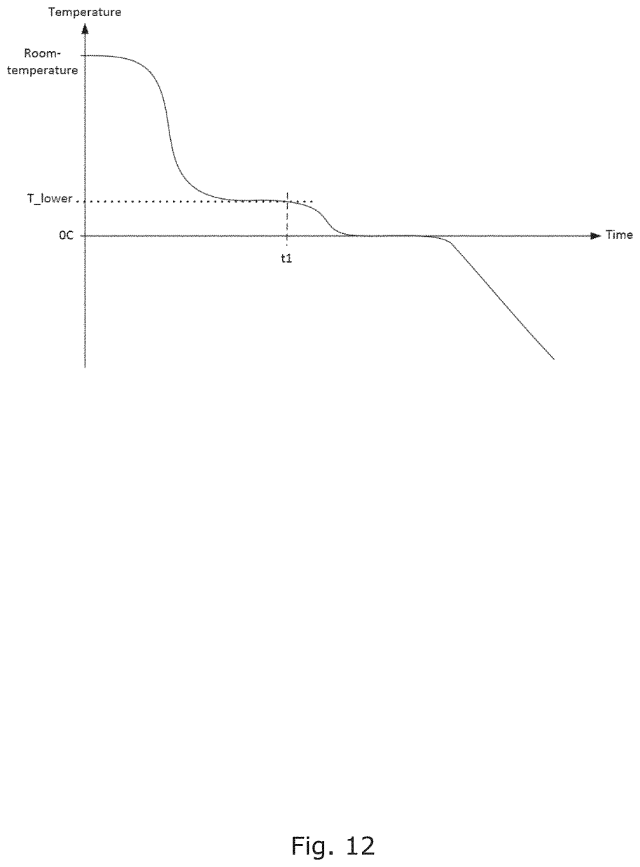

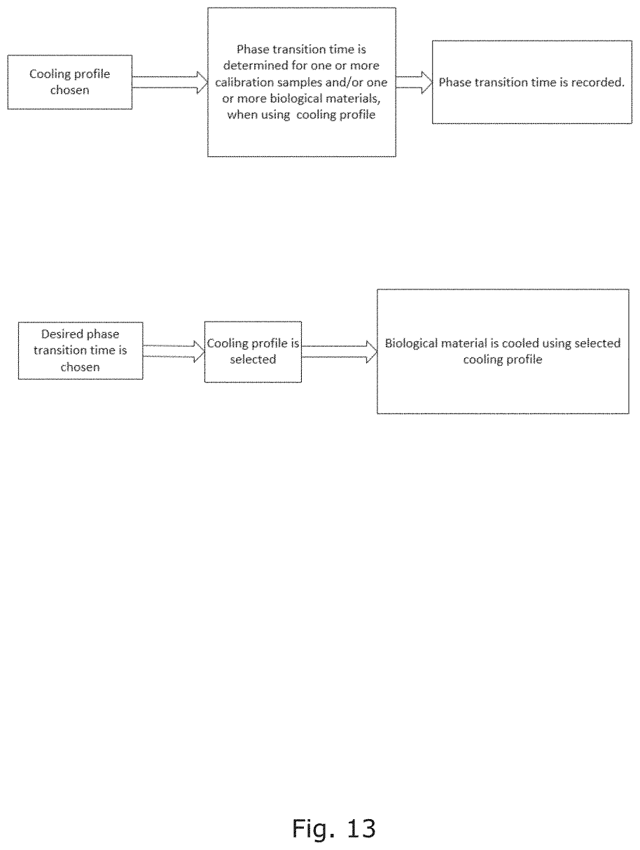

T_lower before further cooling, is given below and with reference to FIG. 12:
1. t1 is defined as the time, when the heat removal is increased such that the measured temperature decreases.
2. t2 is determined by using the relevant steps in the first or second method outlined above.
3. The phase transition time or time of latent heat removal is then the time interval between t1 and t2.

The cooling curve of more than one calibration sample may be measured. If so, the ice-forming time may be calculated as the mean of these measurements.

As the latent heat is a material constant given in energy per volume the amount of heat to be removed during the phase transition is, inter alia, dependent on the volume of the material. Further, the shape of the material will influence the heat removal.

Also, containers, which have one or more dimensions that can be considered small are preferred as the temperature gradient across such a dimension will be smaller and thus less significant. Thus, a common sample container like a test tube having a diameter of approximately 10 mm may show a phase transition time of typically 2-3 minutes in the center, while the phase transition time close to the container wall will be typically about 0.5 minutes in the same experiment.

It is here important to note that several factors attributes to the phase transition time and in most embodiment, these factors should be consistent between the sample to be frozen and the calibration sample. In most cases, it is not sufficient to use a pre-determined cooling profile, as the phase transition time can change significantly between otherwise identical samples. A local calibration is therefore needed for the exact conditions present during that particular freeze cycle to determine the cooling needed to achieve a specific latent heat removal time. This is also apparent as none of the above-described methods for finding the phase-transition time may effectively be carried out a priori, they all rely on experimental data or at least a physical sample under cooling. A pre-chosen cooling time and amount is therefore not ideal, as it needs changing based on the specific circumstances present during the cooling. The required cooling amount is fore example greater when the ambient temperature is increased, something that is not anticipated by a pre-chosen cooling profile.

The calibration sample and the sample containing the cells need not to have the same composition nor the same phase-transition time. What is important is that a one-to-one mapping occurs, such that the optimal viability of the sample is directly or indirectly matched with the calibration sample, such that when referring to the phase-transition time of the sample is preferable meant to the calibration phase-transition time which is intercorrelated with the viability of the sample with the cells. These could be identical but may be different. As these are cooled using the same cooling profile and under the same conditions and machinery an intercorrelation of data can occur.

Sometimes, if the calibration sample and/or sample containing the cells have different physical properties than the experiment determining the optimal phase-transition time, which will be detailed later, might require intermediate calculation steps. This will in most embodiments be based on empirical data linking the different physical properties of the calibration sample and the sample with the cells. This could be if the quantity of the cells is increase. A simple solution to this would may be to increase the calibration sample with the same percentage amount. Such that if the standard calibration sample, used to find to the optimal latent heat phase, is 10 ml and intercorrelated with 5 ml cells, then if the cells volume are increased to 10 ml, then the calibration is increase accordingly to 20 ml. This insures that the intercorrelation is proportional. When the calibration sample is frozen to find the optimal phase transition time the cooling may be used directly on the sample containing the cells.

Based on a cooling profile of a calibration sample and the associated phase transition time it may be possible to achieve a different phase transition time of the sample then the measured phase time of the calibration sample by adding more or less cooling during the process, without the need of freezing another calibration sample and experimentally measure the phase time. The amount of cooling needed to achieve the selected and optimal phase time would be based on empirical knowledge. Such a process is called a static calibration, wherein a posteriori required change of the amount of cooling is calculated/determined based on the phase transition time of the calibration sample and its associated properties. The sample with the cells will be cooled using the new calculated amount of cooling.

In other embodiments a series of calibration sample are frozen in order to empirically find the cooling profile yielding the correct phase transition time. As calibration samples are less expensive then sample with cells, and since the cooling of the cells is highly important, a number of calibration samples are used and the phase transition time calculated experimentally until the right transition time is achieved. The sample with cells will thereafter be cooled using the cooling profile yielding the desired phase transition time, such that the sample is only frozen with the optimal cooling amount. Such a method may also be called a static calibration and is the preferred method for finding the desired phase transition time.

A dynamical process may also, in an embodiment, be used, wherein the cooling amount, based on the chosen phase-transition time, is dynamically changed according to real-time measurements from the calibration sample in order to achieve the desired phase-transition time. This has the advantageous that the calibration sample and the sample with the cells can be placed on the same cooling plate or other apparatus and cooled simultaneous. The calibration sample will then contain equipment for continuously measuring the temperature of the calibration sample. This

The biological material to be frozen may be in a container or on a carrier of some sort. Containers may include e.g. tubes, straws, bags, and ampoules. A suitable container and/or calibration sample should be chosen with regard to the sample of biological material to be frozen.

How the cooling power is achieved is not central to the method. A preferred feature is that the cooling capacity can be controlled in some manner such that the phase transition time can be regulated. By cooling calibration samples in different systems, such as different cooling machines and manufacturers, and altering the cooling capacity, a catalogue of phase-transition time intervals can be made for each system intercorrelated with the cooling amount and efficiency of each machine. By cooling one or more biological samples at the same time or under the same condition as one or more calibration samples, it is possible to determine both a latent heat removal time and a viability of the biological samples.

The cooling sample may therefore cooled alongside the calibration samples, wherein by alongside may both mean spatially next to and during the same cooling cycle as the calibration sample or by a separate but the same, such as exactly the same, cooling cycle.

As will be apparent later, an optimal latent heat removal time exist. This is not as small as possible nor as long as possible, but has, on a viability as a function of latent heat removal time, a peak. This peak can be determined and stored in a catalogue for one or more samples by measuring the latent heat removal time for the calibration sample and the viability of the biological samples. This is done for a number of different latent heat removal times, wherein an optimal latent heat removal time is recorded for different types of samples and cells and optionally other factors, such as type of machine, elevation above sea-level etc. The catalogue can in some embodiments be more detailed, such as the latent heat phase is further divided into specific calibrations samples, such as one for the isotonic saline solution and one for the isotonic salt solution etc.

This ensures that by calibrating the cooling such that the calibration sample has the optimal phase transition time, optionally based on experimental data, then the biological sample frozen with the same cooling profile will have optimal cell viability.

In an embodiment, biological materials may be frozen using an improved method by cooling the biological material 12 in such a manner where the calibration sample 11 is defined to have changed from liquid to solid phase in a phase transition time within an interval of 0.5-6.0 minutes. That is, the biological material is cooled using a cooling profile, which results in a calibration sample having changed from liquid to solid phase in a phase transition time being less than 6 minutes.

In an embodiment, the calibration sample 11 is defined to have changed from liquid to solid phase in a phase transition time in an interval of 0.5-3.0 minutes. That is, the biological material is cooled using a cooling profile, which results in a calibration sample having changed from liquid to solid phase in a phase transition time in an interval of 0.5-3.0 minutes.

In an embodiment, the method is characterized in that a cryoprotectant is not added to the container 1 containing the biological material 12.

In another embodiment, the method of freezing biological material comprises adding a small amount of cryoprotectant to the container 1 containing the biological material 12.

In an embodiment, the small amount of cryoprotectant added to the container 1 constitutes preferably 15% or less of the total sample volume, such as 10% or less or such as 5% or less of the total sample volume, such as 4% or less, such as 3% or less, such as 2% or less or such as 1% or less, or such as 0.5% or less.

In an embodiment, the method of freezing biological material comprises the use of synthetic medium free from serum.

In an embodiment, the method of freezing biological material comprises thawing said biological material by applying one of the above described methods in reverse yielding a thawing time equivalent to the preferred latent heat removal time.

In another embodiment, the method of freezing biological material comprises thawing said biological material by applying any standard procedure for thawing of the biological material.

In a second aspect, the invention provides an apparatus for freezing a biological material.

In an embodiment, the apparatus for freezing of biological material comprises a cooling system and a system to control the cooling power.

In an embodiment the cooling system comprises a freezer, such as e.g. a vapor-compression freezer.

In an embodiment, the control of the cooling power comprises a means for setting a time, wherein the time set is the duration of latent heat removal from a calibration sample.

In an embodiment, the calibration sample comprises an isotonic saline solution.

In another embodiment, the calibration sample comprises a solution comprising growth medium with serum.

In another embodiment, the calibration sample comprises a solution comprising growth medium without serum.

In a further embodiment, the calibration sample is one or more of the biological samples to be frozen.

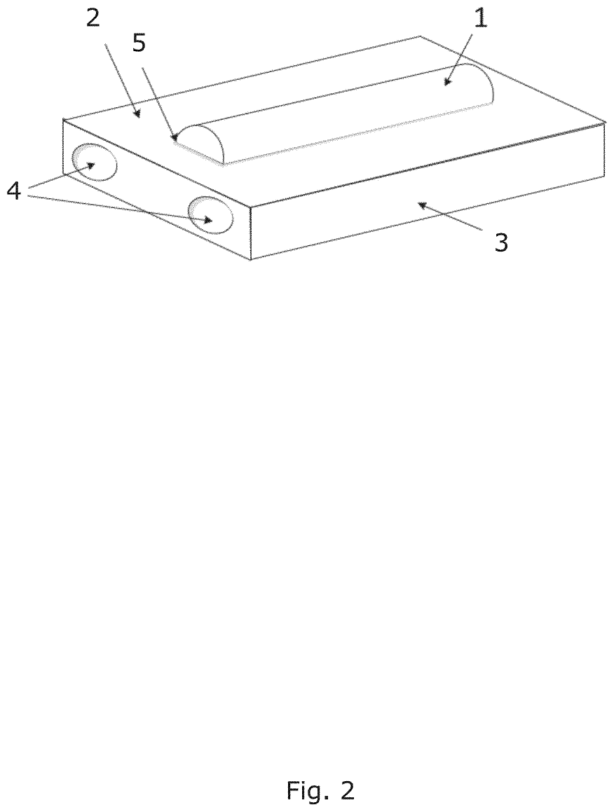

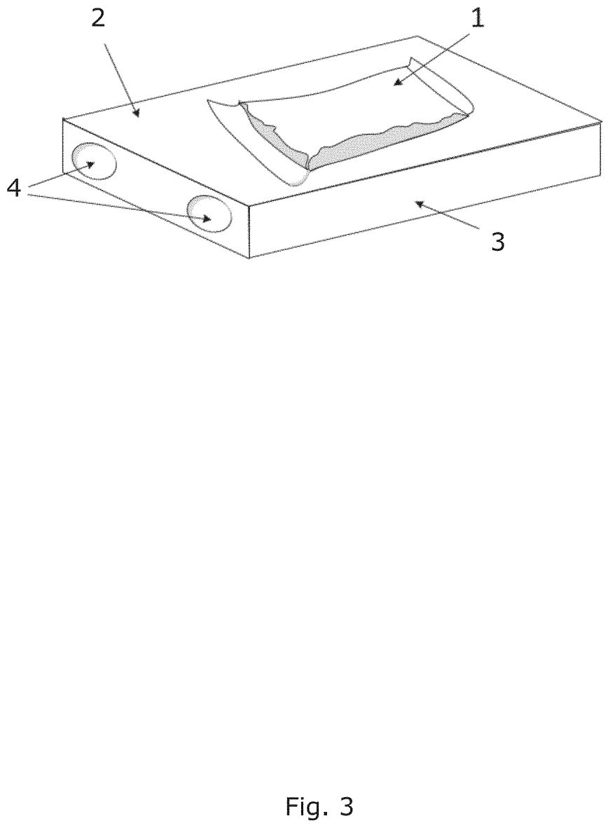

In FIGS. 2 and 3 is shown an embodiment, where the apparatus for freezing a biological material comprises a first plate member 2.

In an embodiment, with reference to FIGS. 2 and 3, the first plate member 2 can hold one or more calibration samples 11 and/or one or more biological samples 12 and/or one or more sample containers 1 containing biological material.

In another embodiment, with reference to FIGS. 2 and 3, the first plate member 2 may be made entirely of a heat conductive material or may comprise a heat conductive material, where the heat conductive material may cover only part of the first plate member 2.

In an embodiment, with reference to FIGS. 2 and 3, the first plate member 2 can be cooled by being in thermal contact with a cooling system such as e.g. a cooling fluid. Such a cooling fluid may stream through the first plate member 2 or in a construct 3, which is in thermal contact with the first plate member 2, via openings 4 in the first plate member 2 or construct 3.

In an embodiment, with reference to FIGS. 2 and 3, some of the dimensions of the first plate member 2 is 10 cm by 10 cm or 20 cm by 20 cm or larger.

In an embodiment, with reference to FIGS. 2 and 3, the construct 3 preferably comprises a thermally insulating material on one or more of the surfaces not in contact with the sample containers 1 or the biological material.

In an embodiment, with reference to FIGS. 2 and 3, a lid may be placed on top of the one or more biological samples or sample containers containing biological material. Such a lid could comprise a thin metal plate, such as stainless steel, aluminium or copper plate or composite material coated with a thermally insulating material such as a plastic material, such as e.g. a foam plastic material. By placing the lid with the thermally insulating material in contact with the sample or sample container, the biological sample or sample container may come into better thermal contact with the first plate member 2.

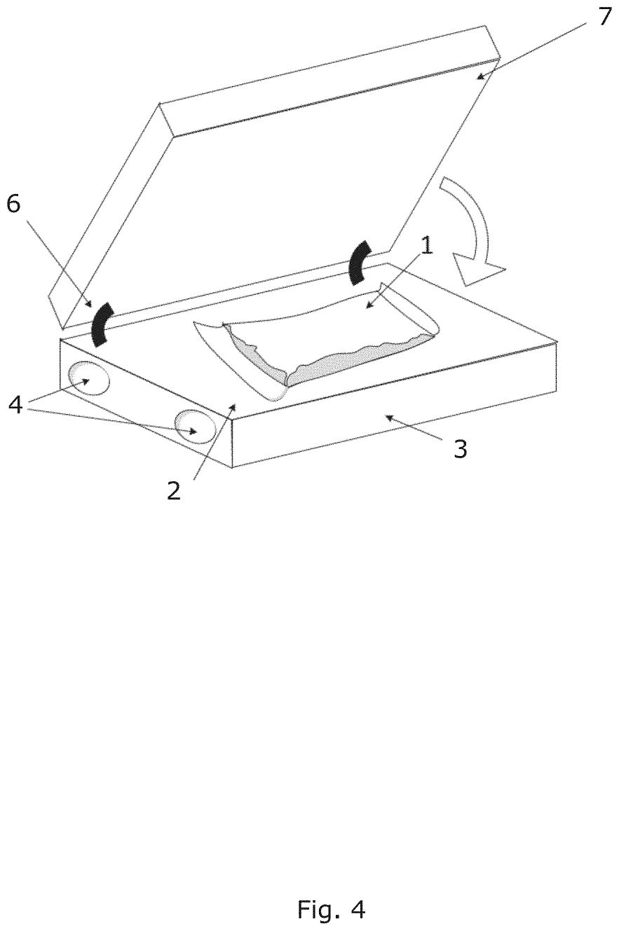

In FIG. 4 is shown an embodiment, wherein the apparatus further comprises a second plate member 7.

In an embodiment, with reference to FIG. 4, the second plate member 7 is in thermal contact with the cooling system.

In an embodiment, with reference to FIG. 4, the second plate member 7 comprises openings 4 through which a cooling fluid may flow.

In an embodiment, with reference to FIG. 4, the temperature of the cooling fluid streaming through the first plate member 2 or the construct 3 and/or the second plate member 7 is between −100 C and +20 C.

In an embodiment, with reference to FIG. 4, the second plate member 7 may be made entirely of a heat conductive material or may comprise a heat conductive material, where the heat conductive material may cover only part of the second plate member 7.

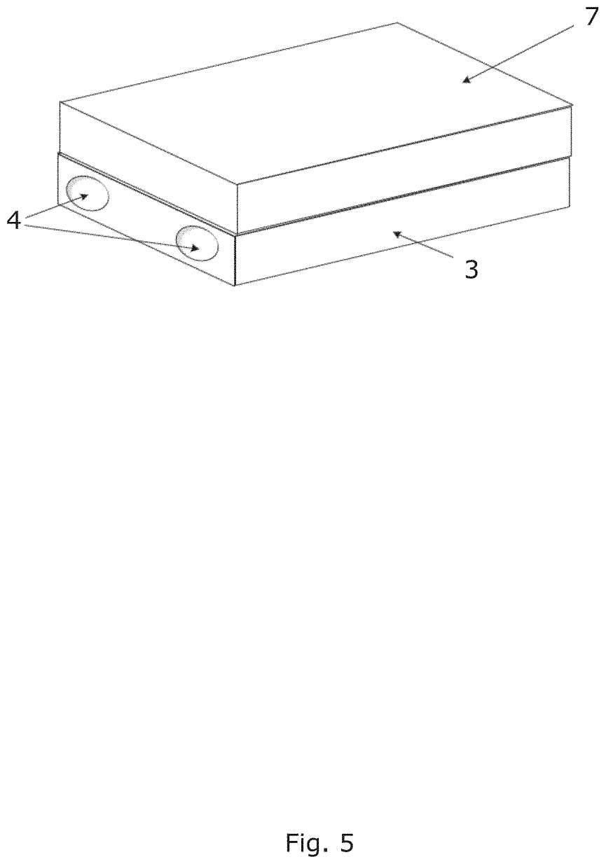

With reference to FIGS. 4 and 5, in an embodiment the first plate member 2 or a part of the construct 3 is mounted on one or more hinges 6 such that the second plate member 7, which is also mounted on the hinge 6, can close on it.

Alternatively, the second plate member 7 is part of a member, which is mounted on the hinge 6, such that the second plate member 7 can close on the first plate member 2.

As it is important to control, as will be apparent when discussing example 7, the latent heat phase, the sample will need a large surface area to volume in order to effectively transfer the cooling to sample. This means that, in an embodiment, the first and second plate member is adapted to fit around the sample. An advantageous sample is one wherein the width and length is much larger than the third dimension, aka the height. This ensures that the whole of the sample receives the cooling, minimizing local temperature variations. In some embodiments, it may be advantageous that the smallest extent of the sample is relatively small, such that the cell suspension inside cools down quickly. For example, for a plastic bag, it can be large in two dimensions, while the third dimension should be small, e.g. less than 25 mm, but preferably <10 mm. That is, the space in which the sample is to be placed has an extension in one of its three dimensions of, for example, <25 mm, preferably <10 mm.

The plates may in some embodiment then enclose the sample, such that the width of the sample's inner diameter, which in the case of test tubes are 10 mm, to fit within the cooling plates. This ensures that a good cooling transfer occurs.

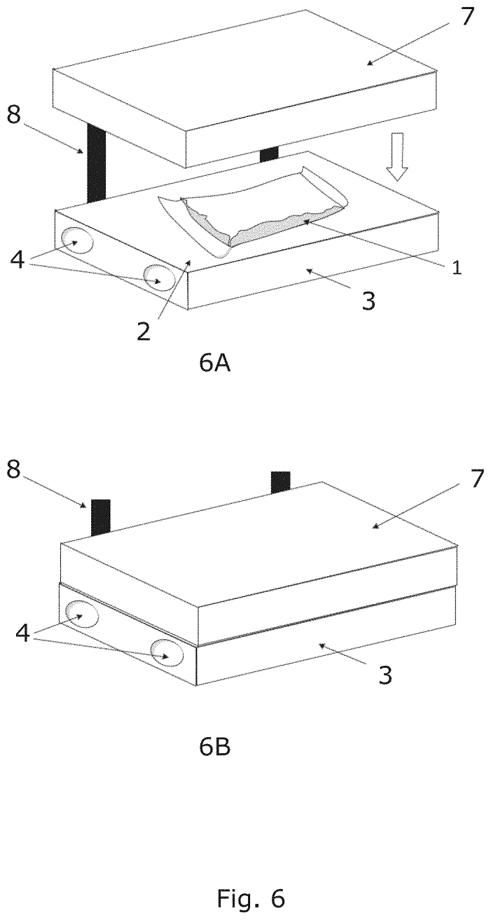

With reference to FIGS. 6A and 6B, in another embodiment the first plate member 2 may be mounted on one or more closing aggregates 8 such that a second plate member 7, which is also mounted the closing aggregates 8 can close on the plate member 2 by one or both of the plates moving in a direction that is perpendicular to a plane defined by the plates.

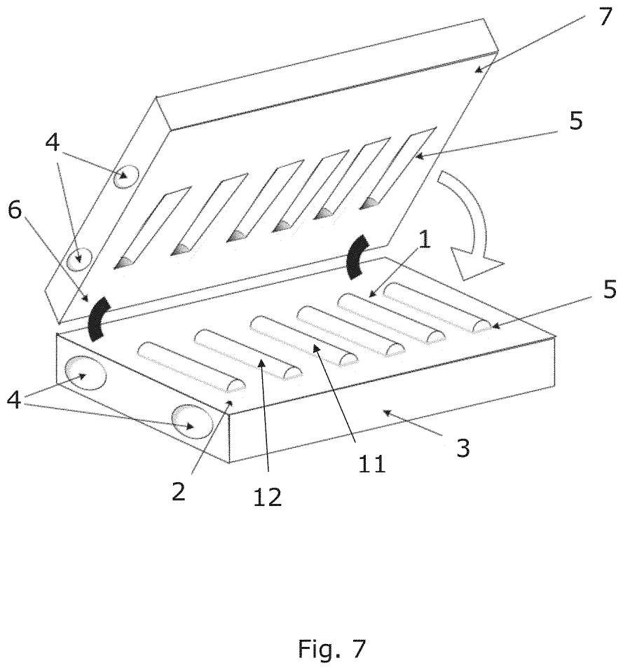

With reference to FIG. 7, in another embodiment the first plate member 2 has one or more indentations 5 to accommodate one or more calibration samples 11 and/or one or more biological samples 12 and/or one or more sample containers 1 containing biological material.

In an embodiment, with reference to FIG. 7, the second plate member 7 may have one or more indentations 5 to accommodate one or more calibration samples 11 and/or one or more biological samples 12 and/or one or more sample containers 1 containing biological material.

In an embodiment, with reference to FIG. 7, the dimensions of the indentations 5 may be such that when a biological sample or a sample container containing biological material or a calibration sample is placed in the indentations they are not wholly contained within the indentation in the first plate member 2, i.e. they extend through a plane defined by an upper surface of the first plate member 2 when disregarding the indentations 5.

In an embodiment, with reference to FIG. 7, the dimensions of the indentations 5 may be such that when a biological sample or a sample container containing biological material or a calibration sample is placed in the indentations 5 they are contained wholly within the indentation in the first plate member 2, i.e. they do not extend through a plane defined by an upper surface of the first plate member 2 when disregarding the indentations 5.

In an embodiment with reference to FIG. 7, the first plate member 2 and/or second plate member 7 comprises one or more changeable inserts. The inserts may be flat or comprise indentations 5 of various sizes and shapes. Such inserts may accommodate different sizes and shapes of objects to be frozen.

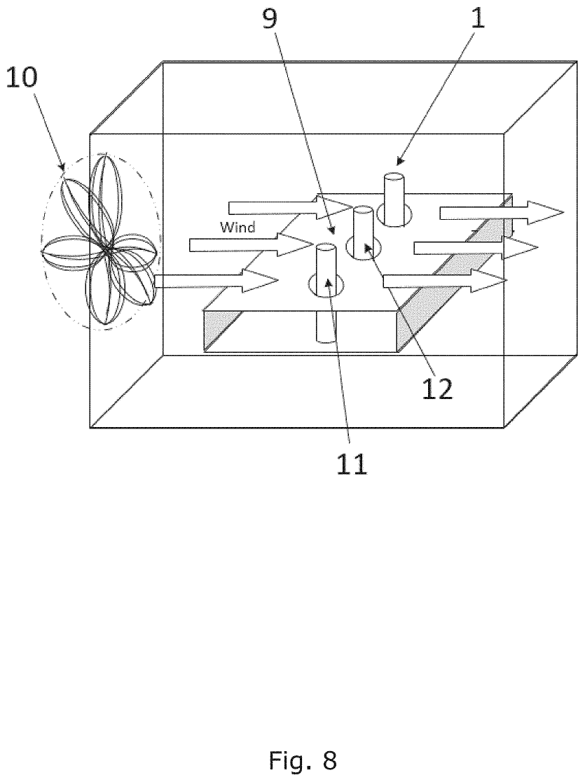

In FIG. 8 is shown an embodiment, where the apparatus for freezing a biological material comprises a wind-generating member 10, which can supply cooling.

In an embodiment, with reference to FIG. 8, the apparatus comprising a wind-generating member 10 further comprises a sample holder 9 for holding one or more calibration samples 11 and/or one or more biological samples 12 and/or one or more sample containers 1 containing biological material.

In a further embodiment, with reference to FIG. 8, the wind speed supplied by the wind-generating member 10 is regulated in the interval between 0.0 m/s-50 m/s, preferably in the interval between 0.1 m/s-50 m/s.

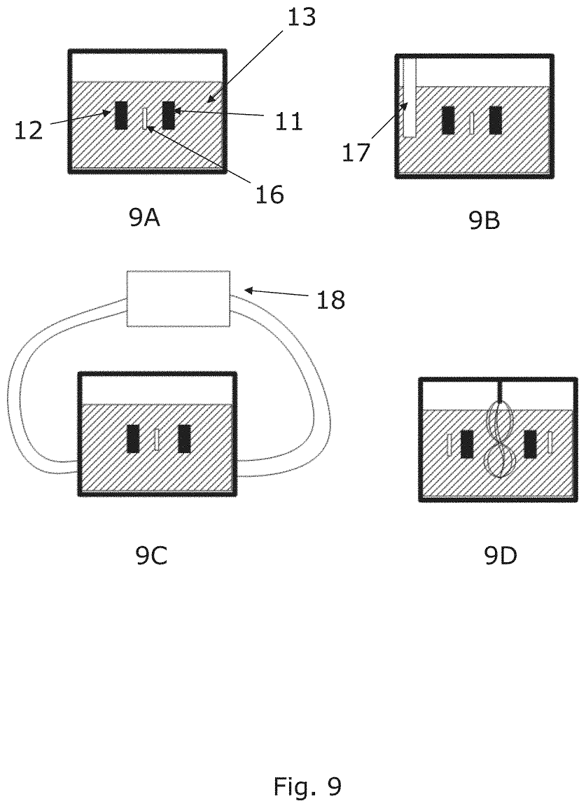

In FIG. 9A is shown an embodiment, where the apparatus for freezing a biological material comprises a cooling bath 13.

In an embodiment, with reference to FIG. 9A, the cooling bath 13 is used to cool one or more calibration samples 11 and/or one or more biological samples 12 and/or one or more sample containers 1 containing biological material.

In an embodiment, with reference to FIG. 9A, the cooling bath 13 further comprises a thermometer 16 for measuring the temperature of the cooling bath 13. In other embodiment, other ways of measuring the temperature could be by use of an IR-sensor or other temperature gauging sensors.

In FIG. 9B is shown an embodiment comprising a cooling bath and further comprising a cooling rod 17, which is used for cooling the cooling bath.

In FIG. 9C is shown an embodiment comprising a cooling bath and further comprising a bath circulator 18 for circulation of cooling fluid.

In FIG. 9D is shown an embodiment comprising a cooling bath and further comprising a stirring member 19.

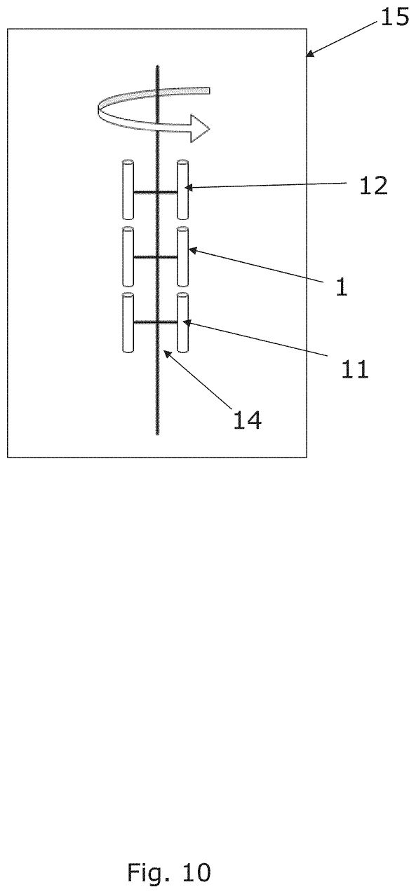

In FIG. 10 is shown an embodiment, where one or more containers 1 are placed on a rotating holder or rack 14 to be cooled by a cooling device 15. The one or more containers 1 may be e.g. cryo-tubes or plastic bags, but are not limited thereto. The rotating holder or rack 14 is preferably suited for the particular type of sample.

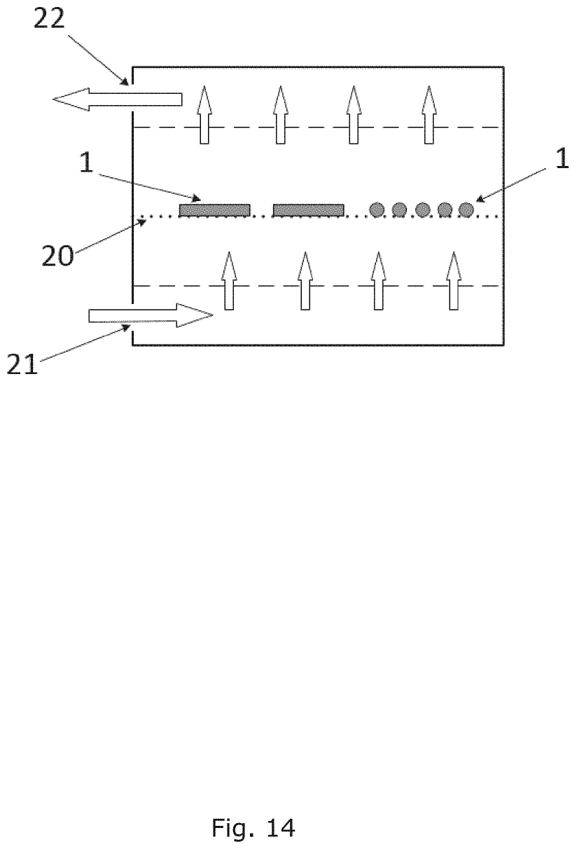

In FIG. 14 is shown an embodiment, where the apparatus for freezing a biological material comprises an inlet 21 and an outlet 22 for cold air. The stream of air is directed such that it flows from beneath a holder 20 and past the holder 20.

In an embodiment, with reference to FIG. 14, the stream of air exerts enough force on the containers 1 on the holder 20 that the containers are pushed off the holder.

In an embodiment, with reference to FIG. 14, the cooling power is regulated by changing the temperature of the streaming air.

In an embodiment, with reference to FIG. 14, the holder 20 has holes in it.

In an embodiment, with reference to FIG. 14, the holder 20 is a mesh.

In an embodiment, with reference to FIG. 14, the mesh is made of a metal.

In an embodiment, with reference to FIG. 14, the mesh is made of a composite material.

In an embodiment, with reference to FIG. 14, the apparatus is operated in a batch mode.

In an embodiment, with reference to FIG. 14, the apparatus is operated in a continuous mode.

In an embodiment, with reference to FIGS. 2 and 3, the first plate member 2 comprises a magnetic field generating means.

In an embodiment, with reference to FIGS. 4-7, the second plate member 7 comprises a magnetic field generating means.

In an embodiment the magnetic field generating means are permanent magnets.

In another embodiment the magnetic field generating means is an electromagnet.

The magnetic field may be produced by assembling an array of NdFeB block permanent magnets, such as 12 or 24 block permanent magnets.

In an embodiment the permanent magnets each have a magnetic field strength between 0.0001 and 1.0 T, such as between 0.01 and 1.0 T or preferably between 0,0001-0,1 T.

In an embodiment, with reference to FIG. 26 the magnetic field will be generated by north-south positioning of the magnetic poles.

In an embodiment, with reference to FIG. 26, the magnetic field will be generated from magnets positioned in an angular arrangement such that the north and south poles will be oriented in any possible, angular position between 0-360°, relative to each other, thus also including the positioning of the magnets in north-north or south-south positions relative to each other.

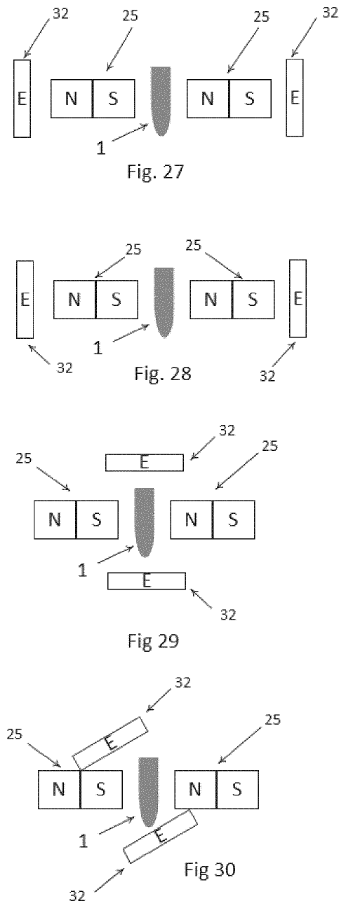

In an embodiment, with reference to FIG. 27, the magnetic field will be generated only on one side relative to a sample.

In an embodiment, with reference to FIGS. 4-7, the first plate member 2 and/or the second plate member 7 comprises an electric field generating means.

In an embodiment, the apparatus comprises a pulsing electric field generating means.

The electric field may be generated from two devices including a pulsed power supply and an electrode pair, which converts the pulsed voltage into pulsed electric fields. A parallel plate capacitor arrangement comprising two aluminium plates directly connected to a functional voltage supply produce a uniform field in the volume between the plates. The gap between the two plates may be filled with air of relative permittivity of one and with zero conductivity.

The pulsed electric field may be a square pulse waveform, or any smooth curved pulse forms, including but not limited to sinusoid shaped curve forms.

In an embodiment, the electric field may be static.

In some embodiments, the pulsing or static electric field generating means have a strength in the range of 0,1-100V/cm, such as between 0,5-2,2V/cm.

In some embodiments, the pulsing electric field generating means have a pulsing frequency in the range of 1-1000 kHz, such as in the range of 5 and 100 kHz.

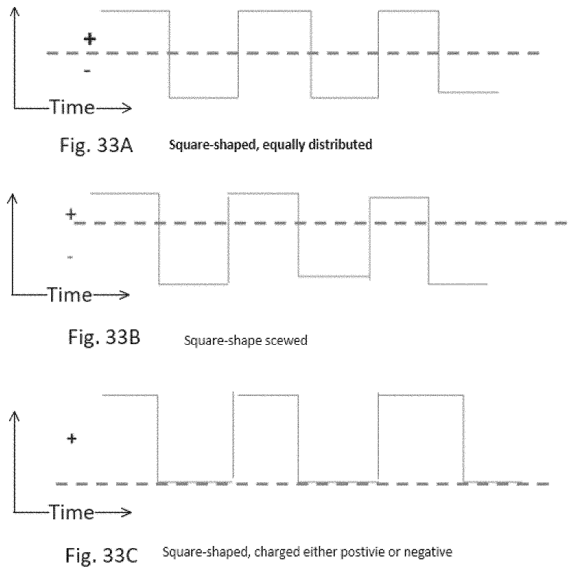

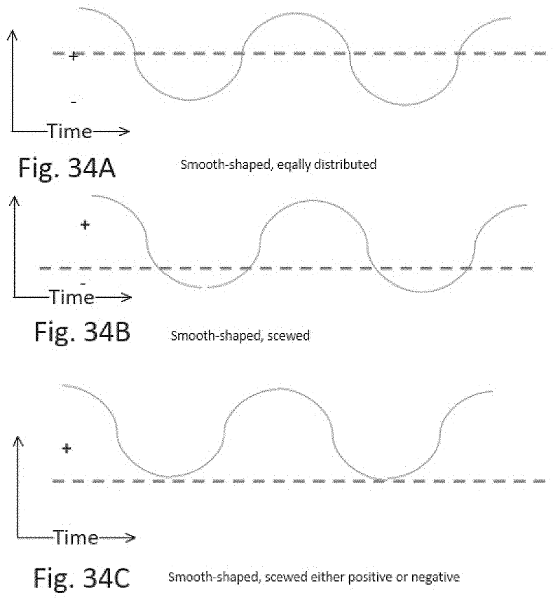

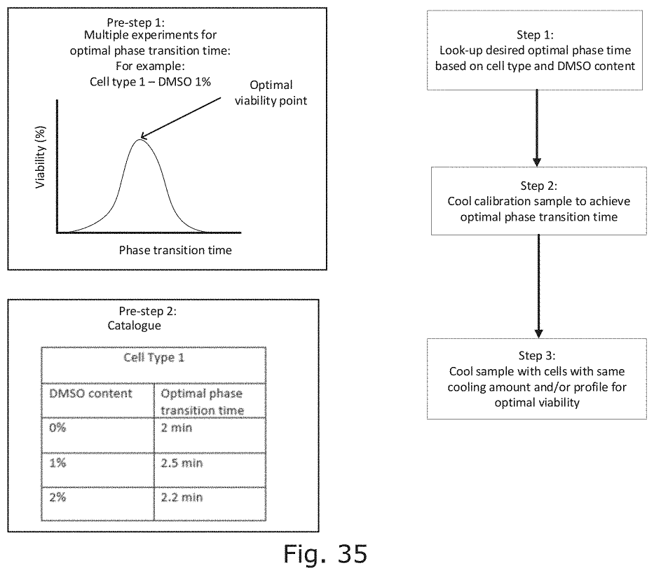

In some embodiments, with reference to FIGS. 33 and 34 the pulsing electric field is entirely positively charged, entirely negatively charged, or shifted to be unequally distributed between positive and negative charges.

In some embodiments, the apparatus comprise both a pulsing electric field generating means and a magnetic field generating means.

In some embodiments, the orientation of 1) magnetic field and 2) electric pulsing or static field are parallel.

In some embodiments, with reference to FIGS. 27-32 the relative orientation of 1) magnetic field, and 2) pulsing or static electric field on the other side, are angular to each other covering all relative positions between 0-360°.

In an embodiment, with reference to FIGS. 4-7, the first plate member 2 and/or the second plate member 7 are made of a non-magnetic material.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

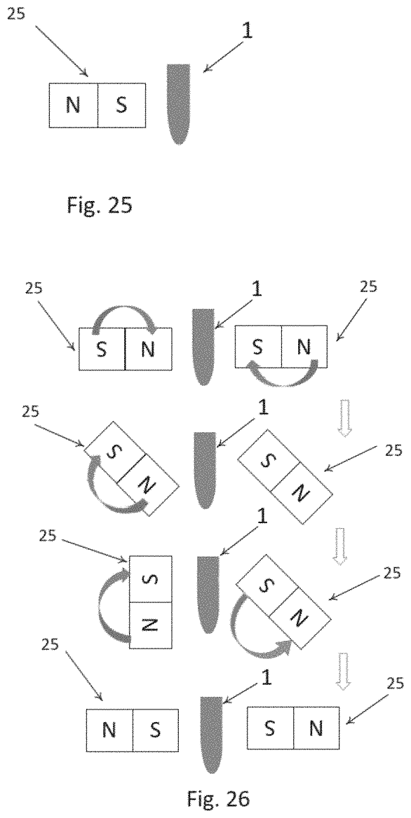

Reference is made to FIG. 25 which schematically illustrates an embodiment of the invention according to which the sample is exposed to a magnetic field, the magnetic field is illustrated by a magnet with poles N and S. The magnetic field may be spatially static or spatially varying, e.g. by rotating the magnet or in general, the magnetic field generation means. In a particular realization of the method or the apparatus, the one or more samples 1 are exposed to a magnetic field, wherein said magnetic field is spatially static, by maintaining the magnetic field generation means at a fixed spatial position relatively to the sample 1, e.g. as illustrated in FIG. 25.

Reference is made to FIG. 26 which schematically illustrates an embodiment of the invention according to which the sample is exposed to a spatially varying magnetic field from two magnetic field generating means 25 illustrated by two magnets rotating spatially arranged on either side of the sample 1; in the figure the spatially varying of the magnetic field is illustrated by for consecutive “snap-shots” between which the magnets are rotated as illustrated by the curved arrows. As also indicated in FIG. 26 is that that the two magnetic field generation means 25 rotates with different rotational speeds. In particular realization of the method or apparatus, the one or more samples are exposed to a magnetic field, wherein said magnetic field is spatially varying. Further, the one or more samples are exposed to a magnetic field, wherein said magnetic field is provided by two or more magnetic field generating means being positioned at different positions relatively to the one or more sample, e.g. as disclosed on either side of the sample 1.

In another interpretation of FIG. 26, this figure represents four static configurations, that is the magnetic field generation means 25 are not rotated so that the figure does not show four consecutive snap-shots, but four different configurations. The embodiment shown at the bottom of FIG. 26 is illustrated as having magnetic poles orientated S-S(south facing south), but this could equally well be N-N(north facing north)

Reference is made to FIG. 27 which schematically illustrates an embodiment of the invention according to which the sample 1 is exposed to a spatially static electrical field by electrical field generation means and a spatially static magnetic field. In a particular realization of the method or apparatus, the one or more samples 1 are exposed to a pulsing electrical field, wherein said electrical field is spatially static, e.g. by the electrical field generation means, such as an electrical conductor, are arranged in spatially static positions. It is noted that although the magnetic field generation means 25 are shown as being positions in-between the sample 1 and the electrical field generation means 32, the electrical field generation means 32 may be arranged in-between the sample 1 and the magnetic field generation means 25.

Reference is made to FIGS. 28-30 which schematically illustrate different embodiments of the invention according to which the sample 1 is exposed to a spatially static magnetic field and a spatially static electrical field, but with different orientations relatively to each other.

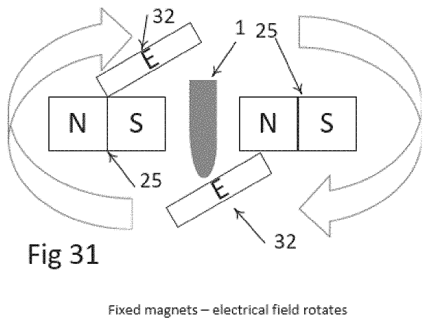

Reference is made to FIG. 31 which schematically illustrated an embodiment of the invention according to which the sample is exposed to a spatially static magnetic field and a spatially varying electrical field illustrated by the electrical field generation means are rotated (curved arrows). The electrical field may beside being spatially varying also be timewise varying, e.g. as a pulsing electrical field. Accordingly, the one or more samples may exposed to a pulsing electrical field, wherein said electrical field is also spatially varying.

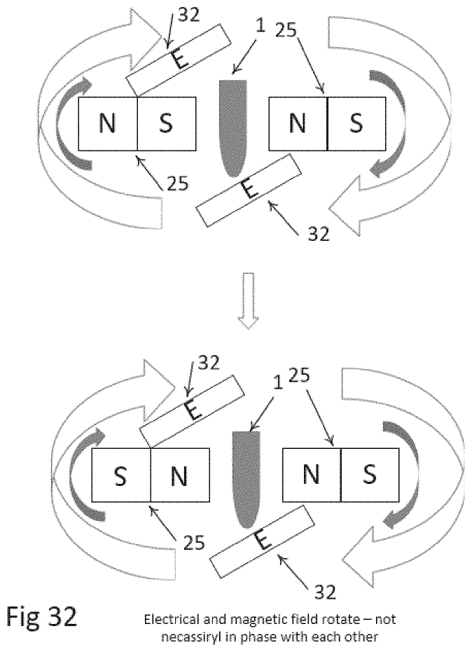

Reference is made to FIG. 32 which schematically illustrates an embodiment of the invention according to which the sample 1 is exposed to a spatially varying magnetic field and a spatially varying electrical field illustrated by the electrical field generation means 32 and the magnetic field generation means 25 are rotated (curved arrows); FIG. 32 shows two snap-shots. In a particular realization of the method or apparatus, the one or more samples 1 are exposed to a pulsing electrical field, wherein said pulsing electrical field is provided by two or more electrical field generating means 32 being positioned at different positions relatively to the one or more sample, which may be combined—as illustrated in FIG. 32—by a spatially varying magnetic field. In another interpretation of FIG. 32 being within the scope of the invention, the electrical and magnetic fields are rotated to various permanent, relative positions, or rotated continuously, not necessarily in phase with each other. That is, the upper part of FIG. 32 represents one static configuration and the lower part of FIG. 32 another static configuration.

Please observe that the magnetic fields are rotated so the magnetic poles changes from N-S(north facing south) to N-N(north facing north) positions. Although, the later alternative is disclosed as N-N, it could equally well be S-S(south facing south).

FIGS. 33A-C schematically illustrate different waveforms, square-shaped forms, of the electrical voltage applied to the electrical field generation means; although a similar variation in electrical field is aimed at, the material of the electrical field generation and the wires thereto will provide a slightly distorted electrical field. However, since in many practical embodiments, the resistance of the wires is in the milli-ohm and the capacitance in pico-farad, the time constant involved may be in the pico-second region, which provides what herein is considered a “sharp square shaped electrical field” mimicking what is shown in FIG. 33A-C.

In FIG. 33A the waveform is “Square-shaped, equally distributed in time and magnitude”. In FIG. 33B the waveform is Square-shaped, equally distributed in time and skewed in magnitude“. In FIG. 33C the waveform is “Square-shaped, equally distributed in time and biased magnitude towards either positive (shown) or negative)”.

FIGS. 34A-C schematically illustrate different waveforms, smooth forms, such as sinusoidal, of the electrical voltage applied to the electrical field generation means. In FIG. 34A the waveform is “Smooth-shaped, equally distributed in time and magnitude”. In FIG. 34B the waveform is Smooth-shaped, equally distributed in time and skewed in magnitude“. In FIG. 34C the waveform is “Smooth-shaped, equally distributed in time and biased magnitude towards either positive (shown) or negative)”.

It is noted that although the magnetic field generation means 25 in FIG. 25-32 are illustrated as permanent magnetic, electro magnets may be applied. When electro magnets are used, the strength of magnetic field may be timewise varying, e.g. by supplying electrical power in accordance with what is disclosed in FIGS. 33-34 for the electrical field.

The methods and apparatuses disclosed in the FIGS. 25-34 may be applied prior to, during and/or after the phase transition.

Without being bound by theory, the inventors have found reasons to suggest that by changing such as rotating the magnetic and/or electrical field, a disturbance of the e.g. water molecules may be introduced and this disturbance may beneficially limit or even prevent the water molecules from forming larger crystals during freezing. However, it is envisaged that the invention is not limited to changing the magnetic and/or electrical field, as it is also within the scope of the invention to apply static magnetic and/or static electrical field where static may refer to spatially and/or timewise varying.

Although the FIGS. 25-32 only discloses one container 1, the configurations disclosed are considered applicable with the methods and apparatus disclosed herein. Therefore, the container 1 as illustrated may by a number of container for biological or calibration sample, e.g. arranged in a container holder 9, as e.g. disclosed in connection with FIG. 8 or as disclosed herein.

The magnetic field and the electrical field may both be applied at the same time or alternations between magnetic field and electrical field may be applied.

### EXAMPLES

General: If nothing else is specified, the phase-transition times are measured in the center of test tubes having a diameter of 10.0 mm, having a liquid volume of about 1.0 ml added to it, and having the sensor measuring the temperature in the sample or in the adjacent calibration samples placed in the center of the liquid.

Control experiments show that the phase-transition time at the test tube's wall is approximately 25% of the phase-transition time measured in the center of the liquid. Thus, the actual phase-transition times throughout the samples are actually a combination of 25-100% of the phase-transition times stated.

In experiments involving magnetic and/or electrical fields, these fields are parallel in all the examples and the magnetic fields are orientated N-S.

### Example 1

Example 1 shows the effect of changes in the duration of ice-formation time for cryopreservation of human cells of the two established cancer cell lines T-47D and T98G in presence or absence of 5% DMSO and in presence or absence of overlapping static magnetic—pulsing electric fields.

The objective was to test the importance of the duration of ice-formation time (=time to remove latent heat during ice formation) of seed stocks of two established human cells lines: T-47D breast cancer cells and T98G glioblastoma cells, for viability after thawing. In addition to variation in ice-forming time two variables have been tested:
Cells frozen without DMSO or with 5% DMSO
Cells frozen within a mixed strong magnetic (0.2-0.3 T)-pulsing electric (20V (220V/m)-20kHZ) field (hereinafter termed “Strong MAG/PEF”), or just outside the Field Box in a weak magnetic (0,005-0,008T)-pulsing electric (7-16V (75-185V/m)-20 kHz) (hereinafter “Weak MAG/PEF) field.

The experiment aimed to determine the influence of reduced ice-formation times down to 1 min and in addition determine the probability that a strong or weak magnetic-pulsing electric field and/or the presence or absence of DMSO influence on the fraction of cells retaining their full proliferative capacity after freezing.

The cells of both types were grown as monolayer cultures in RPMI 1640 medium (Gibco, Rockwill, Md., USA) supplemented with 10% fetal calf serum (Gibco), 2 mM L-glutamine, 200 units/I insulin and 1% penicillin/streptomycin (Gibco). The cells were routinely kept in continuous exponential growth by re-culturing twice per week. Harvest for re-culturing or for freezing was done by removing the growth medium, rinsing 2 times in 1.5 ml trypsin EDTA solution (0.05% and 0.02% respectively), and incubating cultures for 5 min at 37° C. in the residual trypsin solution.

A total of 10⁸ cells of each cell line were produced prior to the experiment. Cells were prepared for the experiment by re-culturing from several working stocks on Day 0 and cells were frozen on Day 3.

For each cell type separate preparation of samples for freezing was performed by standard trypsin treatment of several flasks and pooling of the cells after removal of the trypsin solution and re-suspending of the cells in RPMI-medium. After pooling the cell numbers per ml were accurately counted on a flow cytometer and thereafter dilutions of cell suspensions suitable to obtain the concentration of cells desired for transfer to the cryo-tubes were made for each cell type. The final amount of suspension in each cryo-tube was 1 ml. To obtain this amount 0.5 ml of the cell suspension was added and then 0.5 ml of either RPMI or of RPMI supplemented with 10% DMSO was added (so that the final concentration of DMSO was 5% in samples containing DMSO

On Day 4 samples indicated by seed numbers 200, 300, 1000 or 5000 per 25 cm² flask were thawed and cells seeded for colony formation. There were 5 parallel flasks for each sample tested. One control was the traditional procedure used in the laboratory with 5% DMSO and with 30 min in −20° C., 45 min in ˜−80° C. and final storage in liquid N₂. Another control was samples kept at +20° C. with no freezing.

The flasks were incubated for colony formation in a Steri-cult 200 incubator operated at 37° C. and with an atmospheric concentration of CO₂ of 5%. Incubation continued for between 10 and 17 days depending on the growth rate of the cells (T-47D cells have longer cell-cycle duration than T98G-cells). For counting of macroscopic colonies cells were fixed in ethanol and stained with methylene blue. To illustrate differences in appearance after completed incubation some flasks were taken to a scanner for production of photographs of stained colonies.

The results are presented in table 1 below.

For cells cryopreserved without DMSO the plating efficiency for both T-47D cells and T-98G cells at an ice-formation time of 3 minutes, were comparable with standard freezing with DMSO in both strong and weak magnetic field with pulsing electric field. With no magnetic and pulsed electric field, the plating efficiency for both are less favorable than in the presence of magnet and/or pulsing electric fields.

TABLE 1
Ice formation time versus plating efficiency—PE (%):

| | | Time, min | | | | | | | | | |
|---|---|---|---|---|---|---|---|---|---|---|---|
| | | | | | | | | | | | Standard |
| | | | | | | | | | | | freezing |
| | | | | | | | | | | No | with 5% |
| | | 1.0 | 1.3 | 2.1 | 3 | 3.2 | 4 | 5.6 | 8 | freezing | DMSO |
| Cell type | MAG-PEF | Plating efficiency—PE (%) | | | | | | | | | |
| T-47D | **weak | | | | 83.2 | | 13.4 | 2.1 | 0.7 | | |
| T-47D | *strong | | | | 78.6 | | 12 | | 0.72 | | 80-90 |
| T-47D | non | 3 | 8 | 9 | | 23 | | | | 75 | |
| T-98G | **weak | | | | 53 | | | 0.08 | | | |
| T-98G | *strong | | | | 49 | | | | | | 57 |
| T-98G | non | 3.8 | 4 | 5.2 | | 2.1 | | | | 31 | |

*strong magnetic (0.2-0.3 T) − pulsing electric (220 V/m): “Strong MAG/PEF”
**weak magnetic (0.005-0.008 T) − pulsing electric (75-185 V/m) − 20 kHz) (hereinafter “Weak MAG/PEF) field

From the above experiment, two observations can be found. Firstly, when considering T-47D and T-98G cells, both without a magnetic field the plating efficiency decreases when the latent heat phase becomes small and, secondly, that a peak occurs for T-98G, as well as for T-47D. This means that an optimal latent heat phase removal time exist, which ensures optimal viability as detailed previously in the application.

### Example 2

Example 2 shows the effect of changes in the duration of ice-formation time for cryopreservation of adherent CHO cells in presence or absence of 5% DMSO and in presence or absence of overlapping static magnetic—pulsing electric fields.

The objective was to test the importance of the duration of ice-formation (=time to remove latent heat during ice formation) of seed stocks of adherent CHO cells (chinese hamster ovary cells K1 for viability after thawing. In addition to variation in ice-forming time two variables have been tested:
Cells frozen without DMSO or with 5% DMSO
Cells frozen within a mixed strong magnetic (0,2-0,3T)-pulsing electric (20V (220V/m)-20kHZ) field (hereinafter termed “Strong MAG/PEF”), or just outside the Field Box in a weak magnetic (0,005-0,008T)-pulsing electric (7-16V (75-185V/m)-20 kHz) (hereinafter “Weak MAG/PEF) field.

The experiment aimed to determine the influence of reduced ice-formation times down to 2 min and in addition determine the probability that a strong or weak magnetic—pulsing electric field and/or the presence or absence of DMSO influence on the fraction of cells retaining their full proliferative capacity after freezing.

The cells were grown in 162 cm² flasks as monolayer cultures in Ham's F12 medium supplemented with 10% fetal calf serum. The cells were kept in continuous exponential growth by re-culturing twice per week. Harvest for re-culturing or for freezing was done by removing the growth medium, rinsing two times in 1.5 ml trypsin EDTA solution (0.05% and 0.02% respectively), and incubating cultures for 5 min at 37° C. in the residual trypsin solution. The trypsinization was stopped by adding Ham's F12 medium with FBS.

Cells were resuspended and counted using Countess Automated Cell counter with Trypan Blue Stain (0.4%) to estimate the cell viability.

The cell suspension was transferred to 15 ml tube and centrifuged (200 g, 5 min, 4° C.). The supernatant was removed and the cell pellets were resuspended in cold FBS to give a final concentration of 2×10⁶ cells/ml. 0.5 ml of the cell suspension was transferred to 2 ml cryo-tube. Equal volume (0.5 ml) freezing medium with or without DMSO-medium was added to each cryotube to give a final 5% concentration of DMSO and 1×10⁶ cells per ml in each tube.

After 10 days in liquid nitrogen samples were thawed and cells seeded for colony formation. There were 3 parallel flasks for each sample tested. The control was the traditional procedure used in the laboratory with 5% DMSO and with 30 min in −20° C., 45 min in ˜−80° C. and final storage in liquid N₂.

The flasks were incubated for colony formation in a Steri-cult 200 incubator operated at 37° C. and with 5% CO₂ in the atmosphere. Incubation continued for six days. For counting of macroscopic colonies cells were fixed in ethanol and stained with methylene blue.

The results of the experiment are shown in table 2 and 3.

TABLE 2
Ice formation time and plating efficiency, without DMSO

| Ice formation | +: Strong MAG/PEF *) | PE: plating |
|---|---|---|
| time (min, sec) | −: Weak MAG/PEF **) | efficiency (%) |
| 1 min 55 sec | + | 83 |
| | − | 78 |
| 4 min 8 sec | + | 26 |
| | − | 52 |
| 5 min 7 sec | + | 07 |
| | − | 37 |

TABLE 3
Ice formation time and plating efficiency, with DMSO

| Ice formation | +: Strong MAG/PEF *) | PE: plating |
|---|---|---|
| time (min, sec) | −: Weak MAG/PEF **) | efficiency (%) |
| 1 min 55 sec | + | 88 |
| | − | 98 |
| 4 min 8 sec | + | 107 (artefacted) |
| | − | 95 |
| 5 min 7 sec | + | 72 |
| | − | 64 |

*) strong magnetic (0,2-0,3 T)-pulsing electric ((220 V/m): “Strong MAG/PEF”
**) weak magnetic (0,005-0,008 T)-pulsing electric ((75-185 V/m)-20 kHz) (hereinafter “Weak MAG/PEF) field.

The experiment shows that in a combined static magnetic field and pulsed electric field the viability of DMSO-free cryopreserved CHO cells after thawing is comparable with conventional cryopreserved CHO cells with DMSO when the ice-formation time is short, and that the viability is reduced for longer ice-formation times for both DMSO-free cryopreserved cells and for cells frozen with DMSO

Example 3:The objective was to test whether it is possible to maintain blood platelets non-activated and functionally intact in PRP when frozen with short latent heat removal times, and whether the presence of magnetic fields and/or pulsing electric fields influence on the result.

Blood (2.7 mL) was drawn into 0.109 M citrate anticoagulant (0.3 mL/tube) in tubes that successively were centrifuged at 200×g in 12 min. at +20° C. to yield supernatants with platelet-rich plasma (PRP) in volumes of about 1.2 mL/tube.

From each tube 1.0 mL PRP was carefully pipetted into 20 separate cryo-tubes that were sealed and used in freezing experiments. The PRP samples were stored at +20° C. for 20 hours until the freezing processes were initiated. Two samples were kept as controls at +20° C. with no freezing.

Freezing was performed in two samples per test conditions, and the freezing conditions were varied as follows:

Latent heat removal time: 2; 3.5; 4; 5 and 6 minutes Pulsing field: Presence or absence pulsing electric field 220V/m-20 KHz; or 75-185V/m-20 KHz.

Magnetic field: Presence or absence of static, magnetic field 0.2-0.3 T or 0.005-0.008 T.

All samples were allowed to freeze to −70° C. and kept at this temperature for 24 hours and then thawed at +20° C. The PRP samples were inspected for platelet aggregates. None of the PRP-samples, whatever conditions used for freezing, as well as the controls that were not frozen, showed any sign of aggregates proving that the platelets were not activated during the process. Thereafter one of the two sets of PRP were added 1U human thrombin to each tube which in all the tubes caused an immediate platelet aggregation followed by coagulation of the plasma, showing that the platelet aggregation response was active intact after the freezing processes. Some of the samples from the other set of PRP were transferred to glass tubes and added CaCl₂) to a concentration over that of citrate in the samples.

After some minutes platelet aggregates formed, also showing that the aggregations response was intact.

After the aggregation experiment the PRP was subjected to centrifugation at 200×g for 10 minutes to remove any aggregates and leaving any non-aggregated platelet in the supernatant. As measured at 620 nm in a spectrophotometer against proper controls, no non-aggregated platelets were detectable proving that the aggregation was complete.

The experiment shows that it is possible to maintain blood platelets non-activated and functionally intact in PRP frozen with short latent heat removal time, and that the presence of magnetic fields and/or pulsing electric fields did not influence on the result.

### Example 4

The objective was to test lysis of erythrocytes after freezing with short latent heat removal time and thawing.

Eight blood samples of 3.5 mL each where drawn from a healthy, non-medicated male individual into Vacuette K₂EDTA tubes. Two tubes where stored at +20° C. and used for control. The other tubes where positioned adjacent to tubes containing 0.9% NaCl in the freezing apparatus. The tubes containing 0.9% NaCl were equipped with temperature sensors allowing to measure the process of removal of latent heat from the liquid. It is assumed that the removal of latent heat from the 0.9% NaCl-solutions is identical or close to identical to the removal of latent heat from the close standing blood samples. Two blood samples were allowed to freeze in a process where latent heat from ice-formation was removed over a time interval of 2 min. Two other samples were allowed to freeze in a process where latent heat from ice-formation was removed over a time interval of 2 min. 29 sec., whereas the last two blood samples were allowed to freeze is a process where latent heat from ice-formation was removed over a time interval of 4 min. 23 sec. The temperature was successively allowed to drop to −70° C. The blood samples were stored under such conditions for 24 hours before taken out and thawed at +20° C. After the samples had reached +20° C., they were subjected to centrifugation at 2000×g for 15 min. in order to spin down the erythrocyte fraction and leaving a plasma supernatant for further inspection.

The plasma fractions where subsequently split into two parallels and transferred to cuvettes and measured at 550 nm using the plasma from the untreated blood samples as a control. If lysis of erythrocytes had occurred, hemoglobin absorbing light at 550 nm would be measurable in the plasma.

Table 4 shows the results of the experiment, proving that short latent heat removal time did not affect the lysis of erythrocytes under the given conditions.

TABLE 4

| | | Hemoglobin | |
|---|---|---|---|
| | | in plasma | |
| Sample | Latent heat | supernatant, | |
| ID | removal time | g/dL | % lysis* |
| A1 | Control | 0.1 | 0.7 |
| A2 | Control | 0 | 0 |
| a1 | Control | 0 | 0 |
| a2 | Control | 0 | 0 |
| B1 | 2.0 min | 0.3 | 2 |
| B2 | 2.0 min | 0.3 | 2 |
| b1 | 2.0 min | 0.6 | 4 |
| b2 | 2.0 min | 0.6 | 4 |
| C1 | 2 min 29 sec | 0 | 0 |
| C1 | 2 min 29 sec | 0.1 | 0.7 |
| c1 | 2 min 29 sec | 0.1 | 0.7 |
| c2 | 2 min 29 sec | 0.1 | 0.7 |
| D1 | 3 min 36 sec | 0 | 0 |
| D2 | 3 min 36 sec | 0 | 0 |
| d1 | 3 min 36 sec | 0 | 0 |
| d2 | 3 min 36 sec | 0 | 0 |

*Hb in test person: 15 g/dL

### Example 5

The objective was to test the stability of platelets counts after freezing with short latent heat removal time and thawing.

Eight blood samples of 3.5 mL each were drawn from a healthy, non-medicated male individual into Vacuette K₂EDTA tubes. Two tubes where stored at +20° C. and used for control. The other tubes where positioned adjacent to tubes containing 0.9% NaCl in the freezing apparatus. The tubes containing 0.9% NaCl were equipped with temperature sensors allowing to measure the process of removal of latent heat from the liquid. It is assumed that the removal of latent heat from the 0.9% NaCl-solutions is identical or close to identical to the removal of latent heat from the close standing blood samples. The other six blood samples were allowed to freeze in a process where latent heat from ice-formation was removed over time intervals of 1 min. 30 sec. (two samples), 2 min. 54 sec. (two samples), and 3 min. 40 sec (two samples), respectively. The temperature was successively allowed to drop to −70° C. The blood samples were stored under such conditions for 48 hours before taken out and thawed at +20° C. After the samples had reached +20° C., they were subjected to measurement and platelet content by impedance methodology.

Table 5 shows the platelet counts in samples of blood anticoagulated with EDTA after freezing at various time intervals of removal of latent heat, thawing and measurement with impedance technology results. The result prove that the platelets counts remain stable after the freezing and thawing process using short periods of time for removal of latent heat during freezing.

TABLE 5
Platelet counts

| | Unit | | | | |
|---|---|---|---|---|---|
| Sample- | platelet | Measurement | Measurement | | % of |
| ID | count | 1 | 2 | Average | control |
| Control 1 | × 10⁹/L | 188 | 195 | 192 | — |
| Control 2 | × 10⁹/L | 187 | 190 | 189 | — |
| Freeze 1-P1 | × 10⁹/L | 181 | 183 | 182 | 96 |
| Freeze 1-P1 | × 10⁹/L | 185 | 174 | 180 | 95 |
| Freeze 2-P1 | × 10⁹/L | 191 | 186 | 189 | 99 |
| Freeze 2-P1 | × 10⁹/L | 194 | 176 | 185 | 97 |
| Freeze 3-P1 | × 10⁹/L | 190 | 187 | 189 | 99 |
| Freeze 3-P1 | × 10⁹/L | 192 | 185 | 189 | 99 |

Reference interval B-Thrombocytes/platelets, mean:145 348×10⁹/L

### Example 6

A apparatus for applying static magnetic fields and/or electric fields during freezing of biological material according to the present invention was produced. The apparatus, also referred to as field box, was used in the freezing procedure of the previous examples.

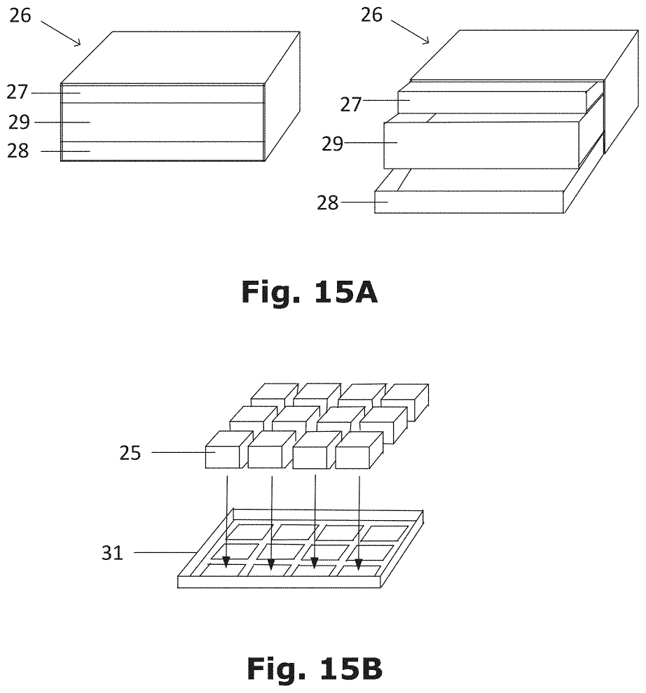

A field box was built from materials with low or no magnetic permeability in nature (aluminum, plastic or mica), with dimensions of 40 cm×30 cm×20 cm and three different compartments. A top and a bottom drawer: 40 cm×30 cm x 5, are used as holders for magnets, whereas the middle part is a 40 cm×30 cm×10 cm treatment chamber, in which samples can be placed in suitable racks to be exposed to pulsed electric and/or uniform static magnetic fields. Reference is made to FIG. 15A illustrating an embodiment of the field box.

The rack in which the freezing procedure could be monitored (i.e. controlling time for removal of latent heat during ice-formation) was made by 1) an aluminium box sized 40 cm×30 cm×10 cm open in two ends, and 2) an aluminium rack where the top surface contained 36 holes of standard cryo-tube type diameter, 3). Furthermore, two fans (diameter 11 cm from tip to tip, 230V AC/0,12 A) was mounted at one end generating an air flow up to 8 m/s (as measured at room temperature), mounted in a square holder of 12 cm×12 cm, and 3.8 cm thick, with max frequency of 2700 rpm, max airflow of 2.66 m³/min.

At different positions in the rack, cryotubes containing 0.9% NaCl was placed containing temperature sensors to allow monitor of the freezing process by connection to a recording instruments. It was assumed that the ice-formation and the process of removal of latent heat monitored in the NaCl corresponded to the freezing process in close positioned samples containing cell suspension to be tested for viability after freezing. The rack was placed in a freezer with the cables from the temperature sensor stretching outside to the recording units. By varying the air-flow through the rack, different time intervals for removal of latent heat during ice-formation could be generated.

The rack was designed to fit into the field box. At the opposite end of the fans, a sleeve was mounted with capacity of a sample rack with up to 16 samples in an environment that be positioned outside the Field Box. The two sample racks were perfectly connected to facilitate the positioning of samples to MAG/PEF-field and control field (=no MAG/PEF field) in one operation.

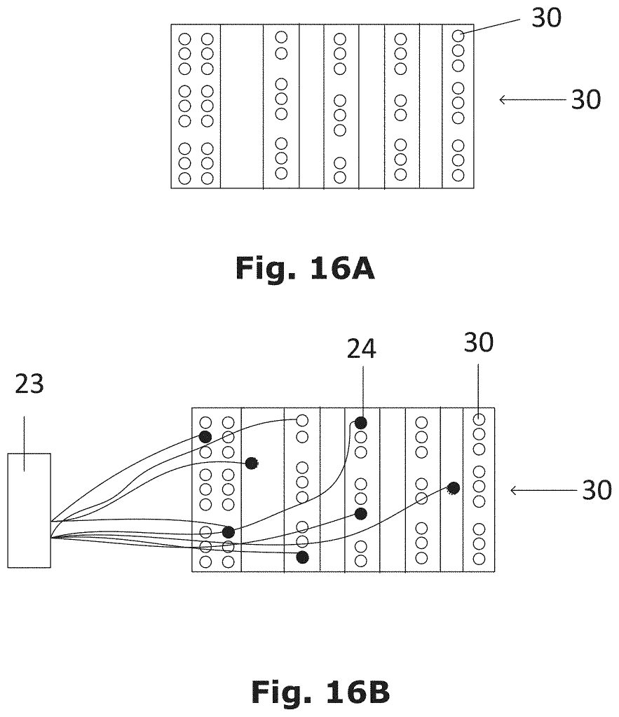

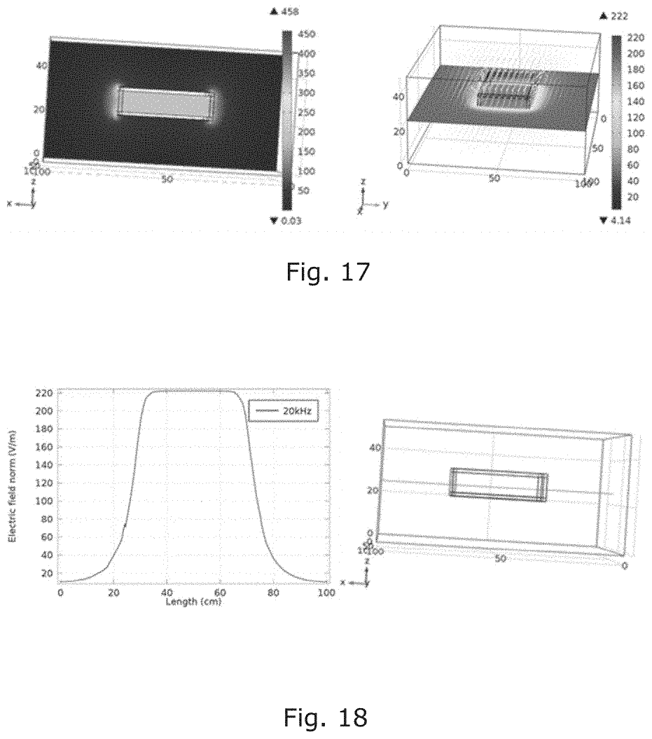

Reference is made to FIG. 16A, illustrating a sample rack according to an embodiment of the present invention. In FIG. 16B, temperature sensors are placed within the holes, e.g in the liquid samples. Furthermore, two sensors are placed “naked”, i.e. outside of the cryo tubes, in the air-stream. The temperature sensors are all connected to a control system.

In addition, two boxes of 30 cm×20 cm×2.55 cm were used for assembling and packing the magnets for subsequent placing in the drawer boxes. These boxes were made from a 2 cm strong plastic frame with a bottom of 1.5 cm waterproof wood and a top of a 0.6 cm plastic mica sheet cover. In the wood 12 identical 5.1 cm×5.1 cm×0.3 cm spaces were made. These were used for attaching thin metal plates (screwed to the bottom wood) in order to keep the magnets in place. Reference is made to FIG. 15B illustrating an embodiment of the magnet holder.

A pulsed electric field (PEF) was created from two devices: a pulsed power supply and an electrode pair, which converted the pulsed voltage into PEFs. A parallel plate capacitor arrangement comprising two aluminium plates of 40 cm×30 cm directly connected to a functional voltage supply produced a uniform field in the volume between the plates. The gap between the two plates is filled with air of relative permittivity of one and with zero conductivity. The pulsed electric field was a square pulse waveform. Two parallel area aluminium plate capacitors separated by 10 cm and connected to a power supply.

The static magnetic field was produced in this field box by assembling 24 NdFeB block permanent magnets (each having a surface field of 0.42 T). 12 magnets were arranged in the top drawer and in the bottom drawer. Each block magnet had dimensions of 5.08 cm×5.08 cm×2.54 cm with spacings of 2.0-2.5 cm.

Simulation was performed for both the pulsed electric field and the static magnetic field, in order to show and verify the field distribution and strength, using COMSOL Multiphysics ver. 5.0., a simulation software package for various physics and engineering applications. The software was based on the finite element method (FEM), a numerical technique in mathematics for calculating approximate solutions of partial differential equations (PDEs) with known boundary conditions. Here the partial differential equation form of Maxwell equations of electromagnetic phenomena could be solved numerically using the software.

The electric field inside and outside the field box horizontally across the middle of the two plates is shown in FIG. 17. The figure shows that the electric field norm is almost constant inside the box and drop significantly and becomes zero when moving away from the box. The electric field norm between the lower plate and the upper plate is also constant as shown in FIG. 5. The figures show that the electric field norm in any direction inside the box is uniform.

The simulation was done using Comsol Multiphysics software (version 5.0) and the results are presented in FIGS. 19 to 24.

Reference is made to FIG. 19 illustrating the magnetic field norm streaming and magnetic flux density (4 magnet side).

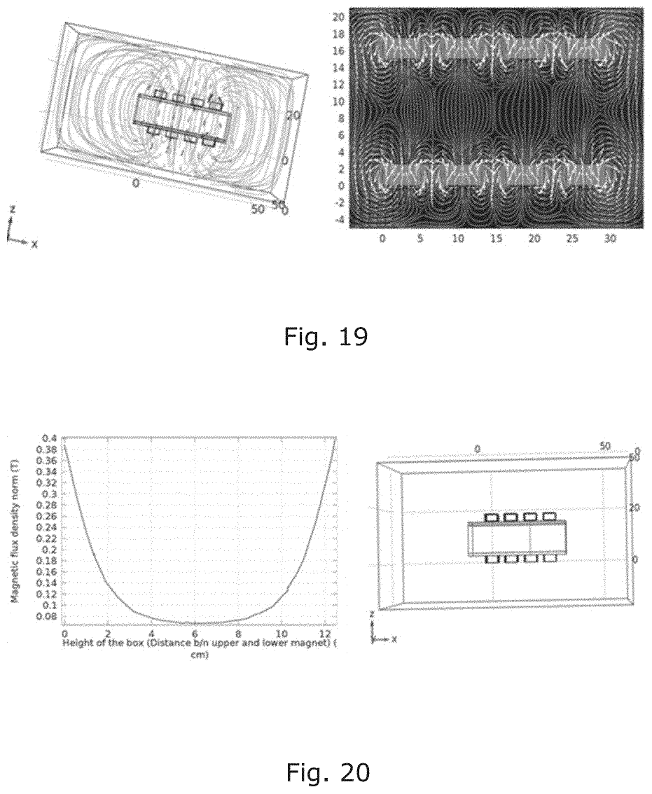

Reference is made to FIG. 20 illustrating the magnetic flux density from the top surface of lower magnet to bottom surface of the upper magnet in the center of the magnet

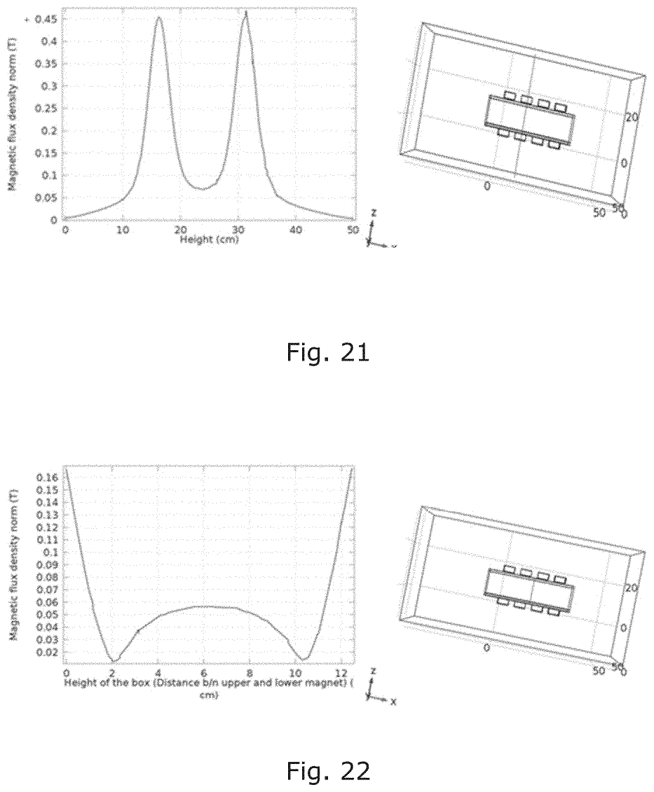

Reference is made to FIG. 21 illustrating the magnetic flux density along the line passing through the centre of the one magnet from each side. This is to show the magnetic flux density distribution above, inside and below the field box.

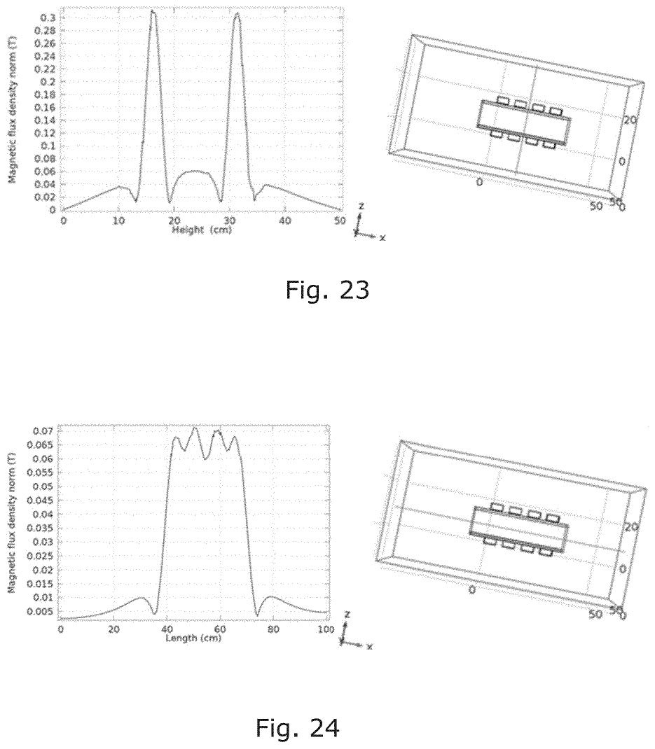

Reference is made to FIG. 22 illustrating the magnetic flux density from the top surface of lower magnet to bottom surface of the upper magnet at the center of the four-magnet junction Reference is made to FIG. 23 illustrating the magnetic flux density along the line passing between two magnets. This is to show the magnetic flux density above, inside and below the field box

Reference is made to FIG. 24 illustrating the magnitude of the magnetic flux density along the mid gap between the upper and lower sets of magnet, which is the centre of the field box.

### Example 7

This experiment aimed to determine the influence of phase-transition times in the interval 2-15 min to remove latent heat in the presence of a combined magnetic (0.2-0.3 T)-pulsing electric fields (20V (220V/m)-20kHZ), in the presence or absence of DMSO (0-5%) measured as the fraction of cells retaining their full proliferative capacity after freezing, monitored with a rapid bioassay-MTS-as an alternative to conventional plating efficiency testing.

The experiment included the standard method used by most researchers, i.e. freezing with 5% DMSO in a “Nalgene Mr Frosty” apparatus (Merck KgaA, Germany), operated with a 15 minutes phase-transition time corresponding to the state of the art freezing rate of 1 degree per minute.

The cells were grown to 70% confluence in 162 cm² flasks as monolayer cultures in Ham's F12 medium supplemented with 10% fetal calf serum (FBS). The cells were kept in continuous exponential growth by re-culturing twice per week. Harvest for re-culturing or for freezing was done by removing the growth medium, rinsing two times in 1.5 ml trypsin EDTA solution (0.05% and 0.02% respectively), and incubating cultures for 5 min at 37° C. in the residual trypsin solution. The trypsinization was stopped by adding Ham's F12 medium with FBS.

Cells were resuspended and counted using Countess Automated Cell counter with Trypan Blue Stain (0.4%) to estimate the cell viability.

The cell suspension was transferred to 15 ml tube and centrifuged (200xg, 5 min, 4° C.). The supernatant was removed and the cell pellets were resuspended in cold FBS to give a final concentration of 2×10⁶ cells/ml. 0.5 ml of the cell suspension was transferred to 2 ml cryo-tube. Equal volume (0.5 ml) freezing medium with or without DMSO-medium was added to each cryotube to give a final 5% concentration of DMSO and 1×10⁶ cells per ml in each tube.

After 15 days in liquid nitrogen samples were thawed and cells seeded for MTS assay as follows:
cells were transferred to 15 ml tubes containing 4 ml culture media (total volume of 4+1=5 ml) and centrifuged at 200×g, 10 min, 4° C.
cells were resuspended in 1 ml media with 1% FBS and further diluted 10 times to give a concentration of 1×105/ml based on the initial counting before freezing.
After dilution, 0.2 ml of cells from each freezing condition was seeded in 96 well plates and the plates were incubated at 37° C. until the next day.
After the overnight incubation, media was removed and 0.1 ml of a fresh 1% FBS media was added. 20 μl of MTS reagent was added.
Finally, OD490 values were read after 1-4 hours incubation. The number of viable cells/well were calculated based on a standard curve generated using ongoing cell cultures. The calculation was performed in GraphPad Prism 8, using four parameter nonlinear logistic regression and the curve fitting function.

The results of the experiment are shown in the table, stating the percentage viability after freezing and thawing:

| Phase- | | | | |
|---|---|---|---|---|
| transition | 0% | 1% | 2% | 5% |
| time, min. | DMSO | DMSO | DMSO | DMSO |
| 1.4 | 4 | 8 | 36 | — |
| 1.8 | 5 | 26 | 57 | 76 |
| 2 | 6 | 36 | 53 | — |
| 2.2 | 7 | 35 | 61 | 74 |
| 2.4 | 10 | 41 | 52 | 90 |
| 2.6 | 11 | 45 | 63 | 98 |
| 2.7 | 21 | 47 | 65 | 97 |
| 3 | 22 | 47 | 66 | 97 |
| 4 | 6 | 4 | 27 | 99 |
| 5.5 | 6 | 4 | 17 | 99 |
| 15 | — | — | — | 68 |

It can be seen from the results that the MTS-bioassay gives generally lower indicated survival rates than the plating efficiency test used in other experiments, and in particular when no DMSO was present. It can further be seen that at all experimental conditions there seems to be an optimal phase-transition time around about 3 minutes, which are less abundant the higher DMSO-levels are used. The experiment demonstrates that considerably lower DMSO-concentrations than the current standards of 5-10% can be used to obtain a reasonable cell survival after freezing and thawing. It can also be seen that the current standard of freezing at 1° C./min over 15 min with 5% DMSO give less favorable results than freezing at shorter phase-transition times.

The experiment also shows that a clear optimal point exist wherein the viability is highest. For the 0% DMSO this is around 3 min. It is therefore highly advantageous to calibrate the cooling profile such that the phase-transition time of the sample is 3 min. Further, it shows that small changes in the phase-transition time will have a significant impact on the viability. The time window for optimal viability is therefore very small.

Further, it is noted that a steep drop in the viability occurs when the optimal point has been surpassed in the positive (towards higher phase-transition times) direction when DMSO is present. See 1% DMSO, wherein the difference between 2 min and 3 min (optimal point) is 13% and between 3 min and 4 min is 39%. This indicates that DMSO has an adverse effect on longer phase-transitions times.

Reference is now made to FIG. 35 showing an embodiment of the invention. First one or more experiments are performed, wherein a sample is frozen with different phase transitions times. The phase transition time is determined by freezing the sample alongside a calibration sample according to the methods presented previously. This is done for a number of different DMSO concentrations and phase-transition times, such that a table according to table 7 is produced.

From this table the viability of the cells is intercorrelated with the phase-transition times so as to produce a phase-transition time vs viability relationship. From these relations an optimal phase time is calculated for each DMSO concentration. This would normally be the peak of the curve, but may differ if other factors are considered, such as the cooling capacities of the machine etc. As shown in table of example 7, these optimal points lies around 3 min. Without being bound by theory, the optimal points are considered to be in the interval of 0.5 to 6 min for a range of cell types. In table of example 7, four optimal phase-transition times has been recorded intercorrelated with the DMSO concentration and cell type.

This is carried out for a number of different DMSO concentrations and cell types, such that a catalogue is produced. This catalogue will be used to determine the optimal phase transition time a specific sample needs to be cooled with, e.g. by a catalogue look-up.

When the right phase-transition time has been found in the catalogue for the specific sample a calibration sample is placed in the cooling apparatus to determine the required cooling under the current conditions for achieving the specific phase-transition time. As mentioned previously the phase transition time is influenced by a number of external factors, such that using the same cooling profile may not ensure that the phase transition time is the same, and as detailed in table 7 small variations in the phase transition time has a big impact on the viability, especially in the higher phase-transition direction.

The calibration could be done as a dynamical process, wherein during the cooling of the calibration sample the cooling is decreased or increased to hit the required phase-transition time or as a static process, wherein a cooling is choosing and a phase-transition time calculated, thereafter an increase or decrease in the cooling is calculated. Preferably, the calibration is such that one or more calibration samples are cooled until the right phase-transition time has occurred, changing the cooling amount and profile between calibration samples. This ensures that one has the most exact phase-transition time.

When the required cooling has been determined for the calibration sample, the sample with the cells is cooled using the same profile. As the phase-transition time has been intercorrelated using the calibration sample's phase-transition time to the viability of sample with the cells, the sample with the cells will automatically have optimal viability based on the catalogue's data.

Different situations may require different DMSO contents and the catalogue will thereby ensure that a phase-transition time for optimal viability can be found based on a number of factors, such as the DMSO content.

In some embodiment, the calibration sample is identical to the sample with cells, wherein the calibration sample also contains cells. In such embodiments, the method for finding the optimal viability may not require two separate container being frozen nor an intercorrelation between them.

However, as cell's quantities is more limited and critical than calibration samples means that, in most embodiments, it is more economical and crucial to use the calibration samples to determine the cooling required to achieved the phase transition time for optimal cell viability.

### LIST OF REFERENCE SYMBOLS USED

1 Container for biological sample or calibration sample
2 First plate member
3 Construction in thermal contact with plate member
4 Openings for cooling fluid
5 Indentations
6 Hinge
7 Second plate member
8 Closing aggregate
9 Container holder
10 Wind-generating member
11 Calibration sample
12 Biological sample
13 Cooling bath
14 Rotating sample rack/holder
15 Cooling device
16 Thermometer
17 Cooling rod
18 Circulator
19 Stirring member
20 Holder
21 Inlet for air
22 Outlet for air
23 Control system
24 Temperature sensors
25 Magnetic field generating means, such as a permanent magnet of electro
magnet
26 box
27 top compartment
28 bottom compartment
29 middle compartment
30 sample rack
31 magnet holder
32 Electrical field generation means, such as an electrical conductor

1. A method of freezing human and/or animal cells in suspension,
wherein one or more samples of human and/or animal cells in suspension (12) contained in container(s) (1) comprise one or more liquids, the method comprising:
determining the cooling needed such that the phase transition time of a calibration sample (11) contained in a container (1) is between 0.5 to 6.0 minutes and chosen such as to ensure optimal viability of the cells of the sample;
cooling said one or more samples (12) in the same manner as said calibration sample (11),
wherein wherein the one or more samples are exposed to a magnetic field and/or a pulsing electric field during at least a part time of the phase transition time, wherein said electrical field is spatially varying.

2. The method according to claim 1, wherein the phase transition time for optimal cell viability is based on experiments wherein one or more calibration sample(s) has been cooled alongside one or more sample(s) and the one or more phase transition time(s) of the calibration sample and the viability of the sample is correlated to find an optimal phase transition time for the viability for the specific sample.

3. (canceled)

4. (canceled)

5. The method of freezing human and/or animal cells in suspension as claimed in claim 1, wherein the strength of the magnetic field is preferably between 0.0001 and 1.0 T.

6. The method of freezing human and/or animal cells in suspension as claimed in claim 1, wherein the strength of the pulsing electric field is preferably between 0.1-100V/cm, and the pulsing frequency preferably is between 1-1000 kHz.

7. (canceled)

8. The method according to claim 1, wherein the one or more samples are exposed to a magnetic field, wherein said magnetic field is provided by two or more magnetic field generating means being positioned at different positions relatively to each other.

9. The method according to claim 1, wherein the one or more samples are exposed to a pulsing electrical field, wherein said electrical field is spatially static.

10. (canceled)

11. The method according to claim 1, wherein the one or more samples are exposed to a pulsing electrical field, wherein said pulsing electrical field is provided by two or more electrical field generating means being positioned at different positions relatively to each other.

12. The method of freezing human and/or animal cells in suspension as claimed in any previous claim, wherein said container (1) does not exceed 100 mm in any dimension, such as does not exceed 50 mm, preferably does not exceed 25 mm.

13. (canceled)

14. (canceled)

15. (canceled)

16. (canceled)

17. The method of freezing human and/or animal cells in suspension as claimed in claim 1, wherein the cooling of said container (1) comprises:
placing said container (1) on a first plate member (2),
regulating the cooling of said first plate member (2) to achieve said cooling, and
a second plate member (7) closing on said first plate member (2).

18. (canceled)

19. The method of freezing human and/or animal cells in suspension as claimed in claim 1, wherein the samples of human and/or animal cells in suspension (12) to be frozen is human cells, animal cells, cell lines, primary cells, stem cells, tissue cells, blood products, embryos, sperm, or fish eggs.

20. An apparatus for freezing samples of human and/or animal cells in suspension, wherein the apparatus comprises a cooling system and a control system to control the cooling power of said cooling system such that a time is set, wherein the time set is the duration of latent heat removal from a calibration sample (11), the apparatus comprises a pulsing electric field generating means, configured to expose the one or more samples to a pulsing electric field, wherein said electrical field generating means is/are arranged spatially varying
and/or
wherein the apparatus further comprises a magnetic field generating means (25), configured to expose the one or more samples to a magnetic field strength, said magnetic field generating means (25) is/are configured for being orientated spatially varying.

21. (canceled)

22. An apparatus as claimed in claim 20, wherein the control system comprises temperature sensors (24) immersed in the calibration sample (11) and wherein the control system (23) determines the cooling needed based on input data from the temperature sensors (24).

23. (canceled)

24. (canceled)

25. (canceled)

26. (canceled)

27. An apparatus according to claim 20, wherein said magnetic field generation means (25) comprising two or more magnetic field generating means (25) being positioned at different positions relatively to the one or more sample.

28. (canceled)

29. (canceled)

30. (canceled)

31. An apparatus according to claim 20, wherein said electrical field generating means comprising two or more electrical field generating (32) means being positioned at different positions relatively to the one or more sample (1).

32. An apparatus as claimed in claim 20, wherein the pulsed electric field are made from a pulsed power supply, an electrode pair and a plate capacitor arrangement comprising two parallel spaced aluminium plates.

33. An apparatus as claimed in claim 20, wherein the apparatus comprises a box (26) made from materials with low or no magnetic permeability in nature, such as aluminium, plastic or mica, the box comprising three different compartments, such as drawers, wherein a top compartment (27) and a bottom compartment (28) are configured to hold the magnetic field generating means (25) and a middle compartment (29) is configured for holding said samples, as well as the calibration sample (11).

34. (canceled)

35. (canceled)

36. (canceled)

37. An apparatus as claimed in claim 20, further comprising a first plate member (2), which can hold a sample of biological material (12), said first plate member (2) being in thermal contact with said cooling system, wherein said first plate member (2) and said second plate member (7) can move in relation to each other.

38. (canceled)

39. (canceled)

40. (canceled)

41. (canceled)

42. (canceled)

43. (canceled)

44. (canceled)
